(19) United States
(12) Patent Application Publication
(10) Pub. No.: US 2024/0425660 A1
(43) Pub. Date: Dec. 26, 2024

(54) COMPRESSIBLE SILICONE FOAM AND METHOD FOR THE MANUFACTURE THEREOF

(71) Applicant: ROGERS CORPORATION, Chandler, AZ (US)

(72) Inventors: Kshitish A. Patankar, Carol Stream, IL (US); Kenneth Mazich, Chicago, IL (US)

(21) Appl. No.: 18/752,948

(22) Filed: Jun. 25, 2024

Related U.S. Application Data
(60) Provisional application No. 63/523,160, filed on Jun. 26, 2023.

(51) Int. Cl. C08J 9/228; C08J 9/00; C08J 9/12; C08J 9/14; C08J 9/36

(52) U.S. Cl. CPC C08J 9/228; C08J 9/0061; C08J 9/0066; C08J 9/125; C08J 9/127; C08J 9/142; C08J 9/36; C08J 2205/00; C08J 2383/06

(57) ABSTRACT

A curable composition for preparing a compressible silicone foam includes an alkenyl-containing component including an alkenyl-diterminated polyorganosiloxane, an alkenyl-substituted MQ polyorganosiloxane, and an alkenyl-substituted copolyorganosiloxane, and a hydride-containing component comprising a hydride-substituted polyorganosiloxane. The curable composition includes a cure catalyst; a filler composition; and a blowing agent. Compressible foams made from the curable composition and methods of making compressible foams from the curable composition are also disclosed.

### CROSS-REFERENCE TO RELATED APPLICATION

This application claims priority to U.S. Provisional Patent Application No. 63/523,160, filed on Jun. 26, 2023, the contents of which are hereby incorporated by reference in their entirety.

### BACKGROUND

This application is directed to a curable composition for preparing a compressible silicone foam, which can be used as a thermal management sheet in batteries, particularly for delaying or preventing thermal runaway in lithium-ion batteries. The application is further directed to methods for the manufacture of compressible silicone foam and battery components and batteries including thermal management sheet(s) including the compressible silicone foam.

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and replacements for lead acid batteries. Due to their increasing use, methods for heat management are desired. For large format applications, such as grid storage and electric vehicles, multiple electrochemical cells connected in series and parallel arrays are often used, which can lead to thermal runaway. Once a cell is in thermal runaway mode, the heat produced by the cell can induce a thermal runaway propagation reaction in adjacent cells, with the potential to cause a cascading effect that can ignite the entire battery.

While attempts to reduce thermal runaway in batteries have been considered, many have drawbacks. For example, modifying the electrolyte by adding flame retardant additives, or using inherently non-flammable electrolytes have been considered, but these approaches can negatively impact the electrochemical performance of the battery. Other approaches for heat management or to prevent cascading thermal runaway include incorporating an increased amount of insulation between cells or clusters of cells to reduce the amount of thermal heat transfer during a thermal event. However, these approaches can limit the upper bounds of the energy density that can be achieved.

With the increasing demand for batteries with improved heat management or reduced risk of thermal runaway, there is accordingly a need for methods and components for use in batteries that prevent or delay the spread of heat, energy, or both to surrounding cells.

### SUMMARY

A curable composition for preparing a compressible silicone foam comprises an alkenyl-containing component comprising, based on the total weight of the curable composition: 30 to 75 weight percent of an alkenyl-diterminated polyorganosiloxane; 0.5 to 5 weight percent of an alkenyl-substituted MQ polyorganosiloxane; 0.1 to 5 weight percent of an alkenyl-substituted copolyorganosiloxane; and a hydride-containing component comprising a hydride-substituted polyorganosiloxane; a cure catalyst; a filler composition; and a blowing agent.

A compressible silicone foam comprising a cured product of the curable composition represents another aspect of the present disclosure.

An assembly for a battery comprising the compressible silicone foam represents another aspect of the present disclosure.

A battery comprising the assembly for a battery and a housing at least partially enclosing the assembly for a battery represents another aspect of the present disclosure.

Another aspect is a method for forming a compressible silicone foam sheet, the method comprising: casting the curable composition onto a first release layer; placing a second release layer on a side of the cast curable composition opposite the first release liner to form a multilayer structure; passing the cast curable composition on the substrate through the nip of two rotating rollers to meter the amount of curable composition; and curing the curable composition to form the compressible silicone foam sheet.

The above described and other features are exemplified by the following figures and detailed description.

### BRIEF DESCRIPTION OF THE DRAWINGS

The following figures represent exemplary embodiments.

FIG. 1 is a schematic, cross-sectional illustration of an aspect of a thermal management sheet.

FIG. 2 is a schematic drawing of an aspect of a thermal management sheet located in between two electrochemical cells.

FIG. 3 is a schematic drawing of an aspect of a thermal management sheet located in between two electrochemical cells.

FIG. 4 is a schematic drawing of an aspect of a thermal management sheet located in a cell array.

FIG. 5 is a schematic drawing of an aspect of an assembly for a battery including the thermal management sheet.

FIG. 6 is a graph of compressive stress (kilopascals (kPa)) versus strain (percent (%)) for various examples.

FIG. 7A is an exploded view of a schematic of a first apparatus for nail penetration testing.

FIG. 7B is a non-exploded view of the schematic shown in FIG. 7A.

FIG. 8A is a graph of temperature (C) versus time (seconds(s)) during a nail penetration test of example 2.

FIG. 8B is a graph of voltage (V) versus time (seconds(s)) during a nail penetration test of example 2.

FIG. 9A is a graph of temperature (C) versus time(s) during a nail penetration test of example 2.

FIG. 9B is a graph of voltage (V) versus time(s) during a nail penetration test of example 2.

FIG. 10 illustrates the apparatus 5000 used for thermal testing.

FIG. 11 is a graph of temperature (° C.) versus time (minutes (min)) detected by the apparatus according to FIG. 10.

### DETAILED DESCRIPTION

Thermal management in batteries, for example, preventing thermal runaway in batteries, especially batteries that include a large plurality of electrochemical cells, is a difficult problem, as a cell adjacent to a cell experiencing a thermal runaway can absorb enough energy from the event to cause it to rise above its designed operating temperatures, triggering the adjacent cells to also enter into thermal runaway. This propagation of an initiated thermal runaway event can result in a chain reaction in which cells enter into a cascading series of thermal runaways, as the cells ignite adjacent cells. It has been particularly difficult to achieve effective thermal management properties in very thin sheets, for example, sheets that have a total thickness of 1 to 30 millimeters, or 1 to 20 millimeters, or 1 to 15 millimeters, or 1 to 10 millimeters, or 1 to 8 millimeters, or 1.5 to 8 millimeters, or 1.5 to 6 millimeters, or 2 to 4 millimeters. Thin sheets are increasingly desired to reduce article size and weight, and to conserve material.

Silicone foam can be stiff and exhibit a steep stress rise in stress-strain response in compression even at low strain levels. Silicone foam can be filled with various materials. For example, silicone foam can be used as thermal runaway prevention material, for example in electric vehicle applications, due to its superior fire-retarding performance, and to meet regulatory standards, the silicone foam can be filled with fire-retardant inorganic materials, fire-retardant organic materials, or a combination thereof. Fillers included in silicone foam can further contribute to undesirable stress-strain characteristics of the silicone foam.

The inventors hereof have found that a silicone foam composition including a filler composition is soft and compressible while maintaining the desired thermal properties and accordingly can be used as a thermal management sheet to prevent or decrease the intensity of cascading thermal runaway events. The foam prepared according to the present disclosure can be used in various sites in batteries to delay or prevent thermal runaway. The foam can further improve the flame resistance of batteries including multiple electrochemical cells. The foam can further decrease stress on adjacent electrochemical cells, thereby extending battery life. As noted above, existing filled foams can exhibit a stiffening behavior, increasing stress on the cells from the foam. Existing foams can also exhibit expansion toward the end of the lifetime of the cell, which can contribute to increased stress on the cells from the aging foam. The excessive stress on the cell from the foam can lead to shortened battery lifetimes, leakage from the cells, or other safety-related concerns.

Accordingly, an aspect of the present disclosure is a curable composition for preparing a compressible silicone foam. The compressible silicone foam is selected to be inert to the ordinary operating conditions of a battery such as a lithium-ion battery and to act as a carrier for the filler composition. To obtain the advantageous properties of the compressible silicone foam, a specific combination of materials for the curable composition is used, as described in greater detail herein. The relative amounts of each component in the curable composition can be adjusted to provide desirable properties in the cured silicone foam.

The curable composition comprises an alkenyl-containing component. The alkenyl-containing composition comprises an alkenyl-diterminated polyorganosiloxane, an alkenyl-substituted MQ polyorganosiloxane, and an alkenyl-substituted copolyorganosiloxane.

The alkenyl-diterminated polyorganosiloxane can be represented by the formula:

MₐD_{b}T_{c}Q_{d},

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from 1 to 40, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group is bonded at the molecular chain terminals, i.e., an alkenyl-terminated polyorganosiloxane. As used herein, an alkenyl-diterminated polyorganosiloxane refers to a polyorganosiloxane wherein two of the chain ends are alkenyl groups. In an aspect, the alkenyl-diterminated polyorganosiloxane is a vinyl-diterminated polyorganosiloxane. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the alkenyl-terminated polyorganosiloxane can be, for example, 0.001 to 3 weight percent, or 0.01 to 0.5 weight percent, or 0.01 to 0.15 weight percent, or 0.01 to 0.1 weight percent, each based on the total weight of the alkenyl-terminated polyorganosiloxane.

Other silicon-bonded organic groups in the alkenyl-terminated polyorganosiloxane, when present, are exemplified by substituted and unsubstituted monovalent hydrocarbon groups having from one to forty carbon atoms, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically useful.

The alkenyl-diterminated polyorganosiloxane can have straight chain, partially branched straight chain, branched-chain, or a network molecular structure, or can be a mixture of such structures. The alkenyl-diterminated polyorganosiloxane is exemplified by vinyl-endblocked polydimethylsiloxanes; vinyl-endblocked dimethylsiloxane-diphenylsiloxane copolymers; vinyl-endblocked dimethylsiloxane-methylphenylsiloxane copolymers; vinyl-endblocked dimethylsiloxane-methylphenylsiloxane-diphenylsiloxane copolymers; vinyl-endblocked dimethylsiloxane-methylphenylsiloxane copolymers; vinyl dimethylsiloxane-methylvinylsiloxane copolymers; vinyl-endblocked methylvinylsiloxane-methylphenylsiloxane copolymers; vinyl-endblocked dimethylsiloxane-methylvinylsiloxane-methylphenylsiloxane copolymers; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; or a combination thereof. In a specific aspect, the alkenyl-diterminated polyorganosiloxane comprises a vinyl-diterminated polydimethylsiloxane.

The alkenyl-diterminated polyorganosiloxane can have a viscosity of 100 to 150,000 centipoise (cP). In an aspect, the alkenyl-diterminated polyorganosiloxane can have a viscosity of greater than 10,000 cP, preferably a viscosity of 50,000 to 150,000 cP. In a specific aspect, the alkenyl-diterminated polyorganosiloxane comprises a vinyl-diterminated polydimethysiloxane having a viscosity of greater than 10,000 cP, preferably a viscosity of 50,000 to 150,000 cP.

In an aspect, the alkenyl-diterminated polyorganosiloxane can comprise more than one alkenyl-diterminated polyorganosiloxanes, for example at least two alkenyl-diterminated polyorganosiloxanes. In a specific aspect, the alkenyl-diterminated polyorganosiloxane can comprise a first alkenyl-diterminated polyorganosiloxane having a viscosity of greater than 10,000 cP, preferably a viscosity of 50,000 to 150,000 cP, and a second alkenyl-diterminated polyorganosiloxane having a viscosity of less than or equal to 10,000 cP, preferably a viscosity of 100 to 500 cP. The first alkenyl-diterminated polyorganosiloxane can be a first vinyl-diterminated polydimethysiloxane, preferably a first vinyl-diterminated polydimethylsiloxane. The second alkenyl-diterminated polyorganosiloxane can be a second vinyl-diterminated polydimethysiloxane, preferably a second vinyl-diterminated polydimethylsiloxane.

The alkenyl-diterminated polyorganosiloxane can be present in the curable composition in an amount of 30 to 75 weight percent, based on the total weight of the curable composition. Within this range, the alkenyl-diterminated polyorganosiloxane can be present in the curable composition in an amount of 35 to 68 weight percent, or 35 to 65 weight percent, or 38 to 65 weight percent, or 40 to 45 weight percent, each based on the total weight of the curable composition.

The alkenyl-containing composition of the curable composition further includes an alkenyl-substituted MQ polyorganosiloxane. As used herein, “MQ polyorganosiloxane” refers to a polyorganosiloxane represented by the formula:

M′ₐD′_{b}T′_{c}Q′_{d},

wherein the subscripts a, b, c, and d are zero or a positive integer, subject to the limitation that if subscripts a and b are both equal to zero, subscript c is greater than or equal to two; M′ has the formula R₃SiO_{1/2}; D′ has the formula R₂SiO_{2/2}; T′ has the formula RSiO_{3/2}; and Q′ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Preferably the subscripts a and d are not zero. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. In a specific aspect, the alkenyl-substituted MQ polyorganosiloxane is a vinyl-substituted MQ polyorganosiloxane.

In an aspect, the alkenyl-substituted MQ polyorganosiloxane can have a viscosity of greater than 500 cP, for example greater than 1,000 cP, or greater than 5,000 cP, or greater than 10,000 cP. In a specific aspect, the alkenyl-terminated polyorganosiloxane can have a viscosity of 5,000 to 20,000 cP, or 10,000 to 20,000 cP.

The alkenyl-substituted MQ polyorganosiloxane can be present in the curable composition in an amount of 0.5 to 5 weight percent, based on the total weight of the curable composition. Within this range, the alkenyl-substituted MQ polyorganosiloxane can be present in an amount of 0.5 to less than 5 weight percent, or 0.5 to 4 weight percent, or 0.5 to 3.5 weight percent, or 0.5 to 3 weight percent, or 0.5 to 2.5 weight percent, or 1 to 2.5 weight percent, each based on the total weight of the curable composition.

The alkenyl-containing component of the curable composition further comprises an alkenyl-substituted copolyorganosiloxane. Suitable copolyorganosiloxanes substituted with an alkenyl group are generally represented by the formula:

M″ₐD″_{b}T″_{c}Q″_{d},

wherein the subscripts a, b, c, and d are zero or a positive integer, subject to the limitation that if subscripts a and b are both equal to zero, subscript c is greater than or equal to two; M″ has the formula R₃SiO_{1/2}; D″ has the formula R₂SiO_{2/2}; T″ has the formula RSiO_{3/2}; and Q″ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. Preferably, the alkenyl-substituted copolyorganosiloxane is an alkenyl-diterminated polyorganosiloxane further comprising alkenyl groups in pendant positions on the molecular chain. For example, the alkenyl-substituted copolyorganosiloxane can comprise a vinyl-terminated polydimethylsiloxane having vinyl pendant groups along the polymer chain.

In an aspect, the alkenyl-substituted copolyorganosiloxane can have an alkenyl content that is higher than the alkenyl content of the alkenyl-diterminated polyorganosiloxane. For example, the vinyl content of the alkenyl-substituted copolyorganosiloxane can be 0.001 to 5 weight percent, or 0.1 to 4 weight percent, or 0.5 to 4 weight percent, or 1 to 4 weight percent, or 2 to 3 weight percent, each based on the total weight of the alkenyl-substituted copolyorganosiloxane.

In an aspect, the alkenyl-substituted copolyorganosiloxane can have a viscosity of less than 1,000 cP, preferably 100 to 500 cP.

The alkenyl-substituted copolyorganosiloxane can be present in the curable composition in an amount of 0.1 to 5 weight percent, based on the total weight of the curable composition. Within this range, the alkenyl-substituted copolyorganosiloxane can be present in the curable composition in an amount of 0.5 to 5 weight percent, or 0.5 to 2.5 weight percent, or 0.5 to 2 weight percent, or 0.5 to 1.5 weight percent, each based on the total weight of the curable composition.

In an aspect, the alkenyl-containing component of the curable composition can optionally further comprise a mono-alkenyl terminated polyorganosiloxane. Suitable mono-alkenyl terminated polyorganosiloxanes can be represented by the formula:

M″′ₐD″′_{b}T″′_{c}Q″′_{d},
wherein the subscripts a, b, c, and d are zero or a positive integer, subject to the limitation that if subscripts a and b are both equal to zero, subscript c is greater than or equal to two; M″′ has the formula R₃SiO_{1/2}; D″′ has the formula R₂SiO_{2/2}; T″′ has the formula RSiO_{3/2}; and Q″′ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. In a mono-alkenyl terminated polyorganosiloxane, only one chain end of the polyorganosiloxane includes an alkenyl group. In an aspect, the mono-alkenyl terminated polyorganosiloxane comprises a mono-vinyl terminated polyorganosiloxane, wherein a vinyl group is a group having the formula —CH═CH₂, and a “substituted vinyl group” has the formula —CH═CR₂, where the R groups can be independently hydrogen or C₁₋₆ alkyl groups. The vinyl concentration in the mono-alkenyl-terminated polyorganosiloxane can be, for example 0.001 to 1 weight percent, or 0.01 to 0.5 weight percent, or 0.01 to 0.25 weight percent, or 0.05 to 0.2 weight percent, each based on the total weight of the mono-alkenyl-terminated polyorganosiloxane. The mono-alkenyl-terminated polyorganosiloxane can have a viscosity of less than 1,000 cP, preferably 100 to 750 cP.

When present, the mono-alkenyl-terminated polyorganosiloxane can be included in the curable composition in an amount of 0.5 to 5 weight percent, based on the total weight of the curable composition. Within this range, the mono-alkenyl-terminated polyorganosiloxane can be included in the curable composition in an amount of 0.5 to 3 weight percent, or 0.75 to 2.75 weight percent, or 1 to 2.5 weight percent, each based on the total weight of the curable composition.

In addition to the alkenyl-containing component, the curable composition comprises a hydride-containing component. The hydride-containing component comprises a hydride-substituted polyorganosiloxane.

The hydride-substituted polyorganosiloxane can have at least two silicon-bonded hydrogen atoms per molecule, and is generally represented by the formula:

M″″ₐD″″_{b}T″″_{c}Q″″_{d},

wherein the subscripts a, b, c, and d are zero or a positive integer, subject to the limitation that if subscripts a and b are both equal to zero, subscript c is greater than or equal to two; M″″ has the formula R₃SiO_{1/2}; D″″ has the formula R₂SiO_{2/2}; T″″ has the formula RSiO_{3/2}; and Q″″ has the formula SiO_{4/2}, wherein each R group independently represents hydrogen, substituted and unsubstituted monovalent hydrocarbon groups having from one to forty, or one to six carbon atoms each, subject to the limitation that at least two of the R groups are hydrogen. For example, each of the R groups of the polyorganosiloxane having at least two silicon-bonded hydrogen atoms per molecule are independently selected from hydrogen, methyl, ethyl, propyl, butyl, pentyl, hexyl, aryl, phenyl, tolyl, xylyl, aralkyl, benzyl, phenethyl, halogenated alkyl, 3-chloropropyl, 3,3,3-trifluoropropyl, or a combination thereof. Methyl and phenyl can be preferred.

The hydrogen can be bonded to silicon at the molecular chain terminals, in pendant positions on the molecular chain, or both. In an aspect, the hydrogens are substituted at terminal positions. In an aspect, at least 3 to 4 hydrogens are present per molecule. The hydrogen-containing polyorganosiloxane component can have straight chain, partially branched straight chain, branched-chain, cyclic, or network molecular structure, or can be a mixture of two or more different polyorganosiloxanes with the exemplified molecular structures.

The hydride-containing polyorganosiloxane can comprise, for example, trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes. In a specific aspect, the hydride-substituted polyorganosiloxane comprises a trimethylsiloxy-endblocked methylhydrogenpolysiloxane.

In an aspect, the silicone hydride-containing component can comprise silicon-bonded hydrogen atoms and an alkenyl group. In an aspect, the alkenyl group can be a vinyl group, and can be positioned at a chain end of the silicon-hydride containing component.

The silicone hydride-containing component can have a hydride content ranging from 0.01 to 10 percent by weight and a viscosity ranging from 10 to 10,000 centipoise at 25° C. In a specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent. In a specific aspect, the hydride-substituted polyorganosiloxane comprises a trimethylsiloxy-endblocked methylhydrogenpolysiloxane having a viscosity of 10 to 50 cP, or 10 to 30 cP, or 15 to 30 cP, or 20 to 30 cP. In yet another specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent and a viscosity of 10 to 50 cP, or 10 to 30 cP, or 15 to 30 cP, or 20 to 30 cP. In yet another specific aspect, the hydride-substituted polyorganosiloxane comprises a α-monovinyl-Ω-monohydride terminated polydimethylsiloxane having a hydride content of 0.01 to 1 weight percent, or 0.01 to 0.1 weight percent, or 0.01 to 0.05 weight percent, a vinyl content of 0.1 to 1 weight percent, or 0.1 to 0.5 weight percent, or 0.2 to 0.8 weight percent, and a viscosity of 10 to 500 cP, or 50 to 400 cP, or 100 to 300 cP.

Combinations of hydride-containing polyorganosiloxanes are also contemplated by the present disclosure.

The hydride-substituted polyorganosiloxane component is used in an amount sufficient to cure the composition, for example, in a quantity that provides a molar ratio of hydride groups to a sum of vinyl and hydroxyl groups of 1.1 to 2.5, or 1.1 to 1.5.

In an aspect, the hydride-substituted polyorganosiloxane component can be provided with a carrier fluid. The carrier fluid is preferably a polyorganosiloxane, for example having the structure

MₐD_{b}T_{c}Q_{d},

wherein M, D, T, Q and the subscripts a, b, c, and d are as previously defined. In an aspect, the carrier fluid can comprise a second alkenyl-terminated polyorganosiloxane, which may be the same or different from the alkenyl-terminated polyorganosiloxane described previously. For example, the second alkenyl-terminated polyorganosiloxane may be different from the alkenyl-terminated polyorganosiloxane described previously in chemical composition, viscosity, or both. In an aspect the second alkenyl-terminated polyorganosiloxane may be different from the alkenyl-terminated polyorganosiloxane described previously in viscosity. Preferably, the second alkenyl-terminated polyorganosiloxane is an alkenyl-diterminated polyorganosiloxane, wherein two of the chain ends are alkenyl groups. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the second alkenyl-terminated polyorganosiloxane can be, for example 0.001 to 1 weight percent, or 0.01 to 0.5 weight percent, or 0.01 to 0.15 weight percent, or 0.01 to 0.1 weight percent, each based on the total weight of the second alkenyl-terminated polyorganosiloxane.

In an aspect, the carrier fluid can comprise a second alkenyl-terminated polyorganosiloxane having a viscosity of greater than 500 cP, for example greater than 1,000 cP, or greater than 5,000 cP. In a specific aspect, the second alkenyl-terminated polyorganosiloxane can have a viscosity of 500 to 10,000 cP.

When included in a carrier fluid, the hydride-substituted polyorganosiloxane component can be present in the carrier fluid in a weight ratio of 10:90 to 90:10, or 50:50 to 85:15, or 60:40 to 70:30.

In addition to the alkenyl-containing component and the hydride-containing component, the curable composition comprises a cure catalyst, a filler composition, a blowing agent, and, optionally, an inhibitor.

The cure catalyst can be a hydrosilylation-reaction catalyst. Effective catalysts promote the addition of silicon-bonded hydrogen onto alkenyl multiple bonds to accelerate cure. Such catalyst can include a noble metal, such as, for example, platinum, rhodium, palladium, ruthenium, iridium, or a combination thereof. The catalyst can also include a support material, such as activated carbon, aluminum oxide, silicon dioxide, polymer resin, or a combination thereof.

In an aspect, the cure catalyst can be present in amounts of up to 1,000 parts per million by weight (ppmw) of metal (e.g., platinum). In an aspect, the cure catalyst can be present in an amount of 1 to 500 ppmw, or 1 to 250 ppmw, or 1 to 100 ppmw, or 1 to 50 ppmw, or 5 to 50 ppmw, or 10 to 50 ppmw.

Platinum and platinum-containing compounds can be preferred, and include, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of the catalyst in a polymer resin such as methyl methacrylate, polycarbonate, polystyrene, silicone, and the like. A combination of different catalysts can also be used. When a platinum catalyzed system is used, poisoning of the catalyst can occur, which can cause formation of an uncured or poorly cured silicone composition that is low in strength. Additional platinum can be added, but when a large amount of platinum is added to improve cure, the pot life or working time can be adversely affected. Methyl vinyl (MviMvi) components can be used as a cure retardant, for example 1-2287 Cure Inhibitor from Dow Corning. Such materials bind the platinum at room temperature to prevent cure and hence, improve the working time, but release the platinum at higher temperatures to affect cure in the required period of time. The level of platinum and cure retardant can be adjusted to alter cure time and working time/pot life. When a higher platinum level is used, it is typically less than or equal to 100 ppmw, based on a total weight of the curable polyorganosiloxane composition. Within this range, the additional platinum concentration (i.e., the amount over that required) can be greater than or equal to 50 ppmw, or greater than or equal to 60 ppmw, based on the total weight of the curable composition. Also within this range, the additional platinum concentration can be less than or equal to 90 ppmw, or less than or equal to 80 ppmw, based on a total weight of the curable composition.

The cure retardant concentration (if a cure retardant is used) is less than or equal to 0.3 weight percent (wt %) of the total curable polyorganosiloxane composition. Within this range, the cure retardant concentration is greater than or equal to 0.005 wt %, or greater than or equal to 0.025 wt % based on the total weight of the curable polyorganosiloxane composition. Also within this range, the cure retardant concentration is less than or equal to 0.2 wt %, or less than or equal to 0.1 wt %, based on the total weight of curable composition and the required working time or pot life.

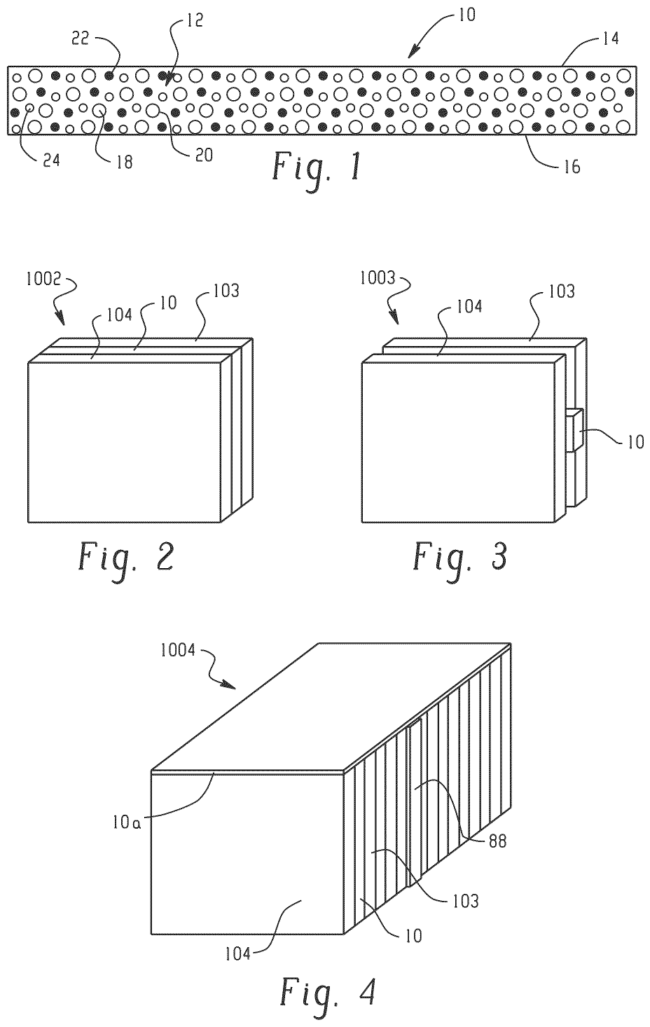

An aspect is shown in FIG. 1, in which thermal management sheet 10 comprises a compressible silicone foam layer 12 having a first outer surface 14 and an opposite second outer surface 16. Although shown as flat, one or both or all of the outer surfaces can be contoured to provide better fit with a surface of an electrochemical cell.

Compressible silicone, foam layer 12 further includes a plurality of openings, i.e., pores 18. The pores are defined by an inner surface 20 of the compressible foam. The pores can be interconnected or discrete. A combination of interconnected and discrete pores can be present. The pores can be wholly contained within the sheet, or at least a portion of the pores can be open to a surface of the sheet, allowing communication with the surrounding environment. In an aspect, at least a portion of the pores are interconnected and at least a portion of the pores are open, allowing passage of air, water, water vapor, or the like from first outer surface 14 to the opposite second outer surface 16, referred to herein as an “open-celled foam”. In another aspect, the foam may be a “closed cell foam”, where the pores may or may not interconnect, and are substantially not open to a surface of the sheet, or are completely closed, such that the sheet does not allow substantial passage of air, water, water vapor, or the like from one outer surface to the other outer surface. In an aspect, the foam is a substantially closed-cell foam, or a completely closed-cell foam.

With further reference to FIG. 1, the filler composition can comprise a filler composition, for example two or more different fillers 22, 24 distributed within the compressible silicone foam layer 12. In an aspect, the filler composition can comprise a single filler 22 distributed within the compressible silicone foam layer 12. The filler(s) can be distributed essentially uniformly, or as a gradient, for example increasing from a first outer surface 14 in the direction of second outer surface 16. As used herein, the phrase “disposed within” can mean that the filler composition is distributed within the matrix of the silicone foam layer as shown in FIG. 1. Further as used herein, the phrase “disposed within” can mean that the filler composition can be located within a pore 18 of the silicone foam layer, for example coating an inner surface 20 of the flexible foam material, or located within the pore in particulate form. A portion of the number of pores in the silicone foam layer can contain the filler composition, or essentially all, or all of the pores can contain the filler composition. Each pore containing the filler composition can independently be partially filled, essentially fully filled, or fully filled.

The filler is preferably in a particulate form to allow easy incorporation into the silicone foam during manufacture thereof. As described above, the filler composition in particulate form can be located within the silicone matrix of the silicone foam layer, within a pore of the silicone foam layer, or both. A portion of the number of pores in the silicone foam layer can contain the filler composition, or essentially all, or all of the pores can contain the filler composition. Each pore containing the filler composition can independently be partially filled, essentially fully filled, or fully filled. In an aspect in which particles of the filler composition are large relative to a diameter of the pore, or the pore is essentially or fully filled with a plurality of smaller particles, movement of the particles within the pore can be restricted. In this aspect, the filler composition can be located in the pores during manufacture of the layer (for example, by including the filler composition in the composition used to form the silicone foam layer), or the filler composition can be impregnated into the pores after manufacture of the silicone foam layer using a suitable liquid carrier, vacuum, or other known method.

A combination of different filler compositions, including different types, forms, or placements can be used. For example, a filler composition in particulate form within a pore of the silicone foam layer can be used in combination with a filler composition distributed within the silicone foam layer.

The filler can be in the form of a particulate material. Particles can be of any shape, irregular or regular, for example approximately spherical, discs, fibers, flakes, platelets, rods (solid or hollow), spherical (solid or hollow), or whiskers. In an important feature, most, essentially all, or all, of the particles have a largest dimension less than the thickness of the layer or the pore in which they are located, to provide a smooth surface to the layer. The particular diameters used therefore depend on the location of the particles. Bi-, tri-, or higher multimodal distributions of particles can be used. For example, when filler particles are present within the matrix of the silicone foam layer and within the pores of the silicone foam layer, a bimodal distribution of particles can be present. A multimodal distribution can be a result of using two different particulate materials, or a single material with two or more size modes. In an aspect, the median diameter (which as defined herein can mean equivalent spherical diameter) of each of the particulate fillers can be 0.1 micrometer (μm) to 1 millimeter (mm), or 0.5 to 500 μm, or 1 to 50 μm.

In an aspect, the filler composition can be a reactive filler composition, comprising at least one reactive filler. As will be understood from the discussion below, the term “reactive” as used in connection with the filler composition includes both chemical reactions and physical processes such as hydrogen bond breaking and formation. The type and amount of reactive filler composition can be first selected to generate water upon exposure to heat. As used herein “generating water” can refer to release of water, for example from a hydrate, or formation of water, e.g., by a chemical reaction process. Furthermore, the water generated can be in the form of a liquid or water vapor. As used herein “water” accordingly includes liquid water, water vapor, or a combination thereof. “Heat” as used herein means heat above the ordinary operating temperature of the battery, and includes heat produced by a flame or contact with a flame. Such temperatures can be 200° C. or higher, or 300° C. or higher, or 500° C. or higher. Without being bound by theory, it is believed that generating water from the reactive filler composition can provide thermal barrier properties by absorbing heat, redistributing heat, or by vaporization of water.

In an aspect, the type and amount of each reactive filler can further be selected to form a thermal barrier layer in situ upon exposure to heat, absorb water, or both. As used herein, a “thermal barrier layer” is a layer that is physically distinct, chemically distinct, or both physically and chemically distinct from the thermal management sheet, and that can provide a conductive or convective thermal barrier to heat, flame, or both. “Thermal barrier layer” is inclusive of char layers as that term can be used in the art, or a water-swelled polymer.

Exemplary reactive fillers can include aluminum trihydrate (also known as aluminum trihydroxide or ATH), ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or waterglass. Sodium borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and BariteWorld. Zinc borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and Barite World. ATH is available from manufacturers such as SAE Manufacturing Specialties Corp., Surepure Chemetals, Inc., Mil-Spec Industries, USALCO, LLC, Cimbar Perfromance Metals, Huber Engineered Materials, LKAB Minerals, MarkeTech International, R. J. Marshall Company, Aluchem, and Alcan Chemicals.

In an aspect, the thermal management sheet comprises at least two fillers having specific properties. In an aspect, the reactive filler composition can comprise at least two of aluminum trihydrate, ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or waterglass. It is to be understood that hydrated mineral fillers and waterglass can be represented by different chemical formulas, and the foregoing are inclusive of the various formulas. Certain hydrated mineral fillers known for use as phase change materials that release water at lower temperatures (e.g., less than 100° C., or less than 200° C.) are not used, to prevent phase change at ordinary operating temperatures.

Fillers that can participate in formation of a thermal barrier layer, absorb water, or both include various sodium, silicon- and boron-containing mineral fillers. A single filler can both generate water and participate in formation of the thermal barrier layer. Exemplary fillers of this type can include ATH, ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or a combination thereof.

In a specific aspect, the reactive filler composition can comprise aluminum trihydrate and zinc borate. This combination can produce water upon exposure to a heat source. The water can expand the silicone foam to provide a counterpressure. Without being bound by theory, generating water can absorb the heat to delay or prevent thermal runaway. Further heat can be absorbed by conversion of liquid water to water vapor. The heat capacity of the ATH and zinc borate can further contribute to heat absorption. A porous thermal barrier layer can form upon exposure to the heat source.

In another aspect, the first and the second filler are selected to both generate water and to also produce a borosilicate glass thermal layer in situ upon exposure to heat. In this aspect, the first and second fillers can include a combination of sodium borate and hydrous sodium silicate. The sodium borate and the hydrous sodium silicate can generate water, and can provide sodium and boron to form the borosilicate glass. Decomposition of the flexible silicon layer can provide silicon to form the borosilicate glass. Also, in this aspect, a combination of ATH, zinc borate, and hydrous sodium silicate can be used. Without being bound by theory, it is believed that during exposure to the heat source, the compressible silicone foam absorbs heat due to the heat capacity of the silicone and sodium borate; the heat of water production and any vaporization from both the sodium borate; and the endothermic formation of borosilicate glass. A thermal barrier layer can form and expand upon exposure to the heat source.

In an aspect, a combination of sodium borate and zinc borate can be used in the reactive filler composition. The borosilicate glass thermal barrier layer resulting from this combination can be both expanded and deformed to form a flexible yet hard layer. The deformation can act as a normal force against the adjacent expanding battery cell, which can decrease or prevent damage caused by an expanding cell that has entered thermal runaway. Without being bound by theory, it is believed that the normal force generation through the pressure of expansion as well as the shape of the char layer can further block convective and conductive heat transfer.

In these aspects, the components and concentrations of the reactive filler composition can be selected to provide staged release of water, thus providing continuous thermal abatement. For example, it has been found that during hot plate testing of a filler composition that includes a combination of sodium borate and zinc borate, heat from the hot plate diffuses into the flexible foam, and generates water vapor in multiple stages, for example first at 140° C. from the sodium borate, and then at 340° C. from the zinc borate. Again without being bound by theory, it is believed that the initial release of water from sodium borate initiates and maintains the generation of the thermal barrier layer, and affects the thickness of the ultimate borosilicate glass thermal barrier layer, and thus the pressure exerted. This process also absorbs heat due to the heat capacity of the silicone, zinc borate and sodium borate; the heat of water production and any vaporization from both the zinc borate and sodium borate; and the endothermic formation of borosilicate glass. Furthermore, the deformation of the filled foam layer can provide a resistance to heat transfer.

In another example of staged water release, a reactive filler composition that includes sodium borate and aluminum trihydrate can generate water vapor first at 140° C. from the sodium borate, and then at 220° C. from the from the decomposition of the ATH.

Another reactive filler composition that can provide a staged water release can include sodium borate, ATH, and zinc borate. This combination can provide a 3-stage water generation system that generates water at 140° C. from the sodium borate, at 220° C. from the ATH, and at 340° C. from the zinc borate.

In an aspect, the reactive filler composition can be further formulated to absorb water that can be trapped or released (recycled). In this aspect, the absorption of water provides an additional mechanism to delay, reduce, or block convective heat transport. Water absorption can further contribute to expansion, to provide additional pressure abatement. In this aspect, the reactive filler composition includes a filler that generates water upon exposure to heat and a filler that can absorb the generated water. The water can be permanently absorbed (i.e., trapped), or releasably absorbed (desorbed), allowing recycling of the water.

In this aspect, the filler that generates water can include sodium borate, zinc borate, ATH, magnesium hydroxide pentahydrate (MDH), or a combination thereof.

A filler that can absorb the generated water includes superabsorbent polymer (SAP). Under some conditions the SAP absorbs and traps water, where the trapped water is only released by decomposition of the SAP. Under other conditions the SAP can absorb and release water without decomposition of the SAP. Superabsorbent polymers are known in the art, such as the hydrolyzed product of starch grafted with acrylonitrile homopolymer or copolymer, such as a hydrolyzed starch-polyacrylonitrile); starch grafted with acrylic acid, acrylamide, polyvinyl alcohol (PVA) or a combination thereof, such as starch-g-poly(2-propencamide-co-2-propenoic acid, sodium salt); hydrolyzed starch-polyacrylonitrile ethylene-maleic anhydride copolymer; cross-linked carboxymethylcellulose; acrylate homopolymers and copolymers thereof such as a poly(sodium acrylate) and a poly(acrylate-co-acrylamide), specifically a poly(sodium acrylate-co-acrylamide); hydrolyzed acrylonitrile homopolymers; homopolymers and copolymers of 2-proenoic acid, such as poly(2-propenoic acid, sodium salt) and poly(2-propencamide-co-2-propenoic acid, sodium salt) or poly(2-propencamide-co-2-propenoic acid, potassium salt); a cross-linked modified polyacrylamide; a polyvinyl alcohol copolymer, a cross-linked polyethylene oxide; and the like. A combination of two or more different SAPs can be used.

The SAP is preferably an electrolyte, such as a salt of poly(acrylate), for example poly(sodium acrylate). The SAP can have a swelling ratio of 15:1 to 1000:1. Higher ratios are preferred. Upon absorbing water, the SAP traps the water and expands. The expansion can act as a normal force against the adjacent expanding battery cell, which can decrease or prevent damage caused by an expanding cell that has entered thermal runaway.

The SAP can optionally be hydrated with water (via spraying, dipping, or other method) in water. For example, the SAP can be hydrated before being incorporated into the silicone foam, or the silicone foam with the SAP can be immersed in water at room temperature water for 24 hours.

Without being bound by theory, it is believed that in this aspect, water is first generated from a filler as the temperature increases (optionally at a variety of temperatures) as described above. The water is absorbed by the SAP. In an aspect, the water absorbed by the SAP is trapped and not released. In another aspect, the water absorbed by the SAP absorbs heat and is then released, exiting the system containing the electrochemical cell, or being absorbed by other dehydrated SAP at a different location in the silicone foam. Ultimately, borosilicate glass can be formed as a continuous and flexible thermal barrier layer.

Another filler that can be used to absorb water is waterglass. As is known in the art, waterglass is soluble in water, and comprises sodium oxide (Na₂O) and silicon dioxide (silica, SiO₂). Under some conditions, the waterglass can absorb water to trap it, or absorb water and release it.

In still another aspect, the reactive filler composition can be formulated to produce waterglass in situ, without decomposition of the flexible silicone layer. In this aspect, the fillers can include sodium borate and hydrous sodium silicate. Other components can be present, such as aluminum trihydrate, magnesium hydroxide, magnesium carbonate hydroxide pentahydrate, or ammonium nitrate, or the like, or a combination thereof. Without being bound by theory, it is believed that heat is diffused into the silicone foam, generating water at a variety of temperatures depending on the combination of water generating fillers used. The remaining ions from the decomposition of the water generating filler can form a Lewis acid or a Lewis base, and react with the hydrous sodium silicate to form waterglass. The water can be released to be recycled. Alternatively, as the water evaporates due to thermal heating, the waterglass solution can solidify to provide a glassy solid that can act as a heat transfer barrier layer inside or outside the silicone foam.

In an aspect, the filler composition can comprise a non-reactive filler. The term “non-reactive filler” as used herein refers to a filler that does not participate in chemical reactions or physical processes such as hydrogen bond breaking and formation. Exemplary “non-reactive fillers” can include, but are not limited to, expanded perlite, unexpanded perlite, glass beads, vermiculite, expanded vermiculite, expanded glass, zeolite, aerogel, silica, porous silica, porous alumina, mica, cork, glass fibers, microspheres, potassium titanate whiskers, or a combination thereof.

The filler composition can be present in the curable composition in an amount of 10 to 70 weight percent, based on the total weight of the curable composition. Within this range, filler composition can be present in an amount of 20 to 60 weight percent, or 20 to 50 weight percent, each based on the total weight of the curable composition.

The curable composition further comprises a blowing agent. In an aspect, the blowing agent comprises a chemical blowing agent. For example, in an aspect, the blowing agent can comprise water, a silanol-terminated polyorganosiloxane, and a C₁₋₁₂ monoalcohol (which includes diols, triols, and the like). The silanol-terminated polyorganosiloxane can have a viscosity of 20 to 40,000 cP, or 400 to 2,000 cP, or 500 to 1,000 cP. In a specific aspect, the silanol-terminated polyorganosiloxane comprises hydroxyl-terminated polydimethylsiloxane. In an aspect, the alcohol preferably comprises a C₁₋₆ alcohol. In a specific aspect, the alcohol comprises 1-butanol. In an aspect, the alcohol may consist of a monoalcohol.

Suitable blowing agents can also include physical blowing agents. Exemplary physical blowing agents include hydrogen atom-containing components, which can be used alone or as mixtures with each other or with another type of blowing agent. These blowing agents can be chosen from a broad range of materials, including hydrocarbons, ethers, esters and partially halogenated hydrocarbons, ethers and esters, or the like. Examples of physical blowing agents have a boiling point from −50 to 100° C., or from −50 to 50° C. Among the hydrogen-containing blowing agents are the HCFC's (halo chlorofluorocarbons) such as 1,1-dichloro-1-fluorocthane, 1,1-dichloro-2,2,2-trifluoro-ethane, monochlorodifluoromethane, and 1-chloro-1,1-difluorocthanc; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluorocthane, (Z)-1,1,1,4,4,4-hexafluoro-2-butene, and pentafluoroethane; the HFE's (halo fluoroethers) such as methyl-1,1,1-trifluorocthylether and difluoromethyl-1,1,1-trifluoroethylether; and the hydrocarbons such as n-pentane, isopentanc, and cyclopentane. In an aspect, the blowing agent can comprise carbon dioxide, nitrogen, argon, water, air, nitrogen, and inert gases (such as helium and argon), as well as combinations thereof. In an aspect, the blowing agent can comprise carbon dioxide, for example solid carbon dioxide (i.e., dry ice), liquid carbon dioxide, gaseous carbon dioxide, or supercritical carbon dioxide.

The blowing agent can be present in the curable composition in a total amount of 0.16 to 2 weight percent, or 0.5 to 2 weight percent, based on the total weight of the curable composition. In a specific aspect, the blowing agent comprises a chemical blowing agent, and the chemical blowing agent can be present in the curable composition in a total amount of 0.16 to 2 weight percent, or 0.5 to 2 weight percent, based on the total weight of the curable composition. In an aspect, water can be included in an amount of 0.01 to 0.5 weight percent, based on the total weight of the curable composition. In an aspect, the silanol-terminated polyorganosiloxane can be present in an amount of 0.1 to 1 weight percent, based on the total weight of the curable composition. In an aspect, the C₁₋₁₂ monoalcohol can be present in an amount of 0.05 to 0.5 weight percent, based on the total weight of the curable composition.

The curable composition can optionally further comprise an inhibitor. Inhibitors suitable for use in the curable composition can include alkenyl-diterminated polyorganosiloxanes which can be represented by the formula:

MₐD_{b}T_{c}Q_{d},

as already discussed above. The function as an inhibitor, the alkenyl-diterminated polyorganosiloxane inhibitor can have a vinyl content of greater than or equal to 15 weight percent (based on the total weight of the alkenyl-diterminated polyorganosiloxane inhibitor), a molecular weight of less than 500 grams per mole (g/mol), or both. In an aspect, the inhibitor is present an comprises an alkenyl-diterminated polyorganosiloxane having have a vinyl content of greater than or equal to 15 weight percent, for example 15 to 40 weight percent, or 20 to 40 weight percent, or 25 to 35 weight percent, each based on the total weight of the alkenyl-diterminated polyorganosiloxane, and a molecular weight of less than 500 g/mol, for example 50 to 450 g/mol, or 100 to 400 g/mol, or 100 to 250 g/mol.

When present, the inhibitor can be included in the curable composition in an amount of 0.01 to 0.4 weight percent, based on a total weight of the alkenyl-containing component and the hydride-containing component in the curable composition.

Other additives can be present in either part of the curable compositions (as discussed herein), for example, an ultraviolet (UV) stabilizer, antistatic agent, dye, pigment, antimicrobial or antiviral agent, and the like, or a combination thereof. When additives are present, the amounts used are selected so that the desired properties of the cured silicone composition are not adversely affected by the presence of the additives.

The curable silicone composition can be manufactured by combining the various components in any suitable order. In an aspect, the curable composition can be provided as a first part and a second part. The first part can comprise the alkenyl-containing component, and the second part can comprise the hydride-containing component. In an aspect, the first part can further comprise one or more of the cure catalyst, the filler composition, the blowing agent, and, when present, the inhibitor. The first part and the second part can be mixed, metered, or cast, for example into a mold or on a continuous coating line, to provide the compressible silicone foam. The foaming and curing then occurs either in the mold or on the continuous coating line. In another method of production, the reactive components of the curable composition can be introduced into an extruder together with the filler composition and a chemical blowing agent or other additives, if used. The catalyst can then be metered into the extruder to start the foaming and curing reaction.

The alkenyl-containing component and the hydride-containing component can be present in the curable composition in amounts effective to provide a weight ratio of alkenyl-containing component: hydride-containing component of 10:1 to 40:1, or 13:1 to 40:1, or 13:1 to 25:1, or 13:1 to 20:1. In an aspect, the curable composition can comprise a molar ratio of hydride groups to a sum of alkenyl and hydroxyl groups of 1.1:1 to 2.5:1, or 1.1:1 to 2:1, or 1.1:1 to 1.5:1.

In an aspect, other components not specifically described herein can be minimized (i.e., present in an amount of less than or equal to 5 weight percent, or less than or equal to 1 weight percent, or less than or equal to 0.5 weight percent, or less than or equal to 0.1 weight percent, or less than or equal to 0.01 weight percent, each based on the total weight of the curable composition) or excluded from the curable composition and the cured silicone foams prepared form the curable compositions. For example, the curable composition can optionally minimize or exclude polymers other than the various polyorganosiloxanes described herein. In an aspect, the curable composition can optionally minimize or exclude surfactants such as fluorinated surfactants. The curable composition or the process of manufacturing the compressible silicone foams described herein can optionally minimize or exclude physical blowing agents. The curable composition can optionally minimize or exclude an insulating filler.

A cured silicone foam layer can be formed by casting the curable composition followed by curing the cast composition. The present inventors have surprisingly discovered that the curable compositions can provide unexpectedly low densities in cast silicone foams. Post-cure can be used to advance cure to near complete status, developing desirable physical properties. The cured silicone foams described herein are considered as free-standing silicone foams. Free-standing as used herein means that no supporting layers are present. Thus any discussion of particular properties associated with the cured silicone foams according to the present disclosure will be understood to refer to the properties of the foam layer itself, in the absence of any supporting layers.

Liquid material inputs of the curable composition can be mixed and cast onto a moving release layer. In an aspect, another release layer is pulled through on top of the cast mixture and the sandwiched mixture is then passed through the nip of two rotating rollers to meter the amount of the curable composition, which determines the thickness of the partially cured foam, and ultimately, the final foam. The gap thickness between the rolls (i.e., the nip gap) can be adjusted to decrease the thickness of the sandwiched mixture as it passes between them. In an aspect, the nip gap can be, for example, 0.005 to 0.5 inch (0.127 to 12.7 millimeters (mm)), or 0.01 to 0.1 inches (0.254 to 2.54 mm), or 0.01 to 0.05 inches (0.254 to 1.27 mm), or 0.02 to 0.04 inches (0.508 to 1.016 mm). During the metering step, the width of the sandwiched mixture can be maintained, but the length of the sandwiched mixture can increase as the thickness decreases. In another aspect, a second release layer on top of the cast mixture and rollers are not used, and a process such as knife-over-roll can be used to determine the thickness of the partially cured foam, and ultimately, the final foam.

The coated release layer passes through an oven, which can be heated by at least one platen, by heated air, other means, or a combination thereof to foam and at least partially cure the cast composition. Two or more curing ovens at the same or different temperatures can be used. Temperatures in the oven(s) can be 80 to 200° F. (43.3 to 60° C.) and residence time for the coated carrier in the oven(s) can be varied to achieve the desired level of cure. Upon exiting the oven, when an additional top layer of carrier film is used, the additional top layer can be removed.

It has been found that only certain carriers provide adequate adhesion to the release layer. A suitable carrier for use with the above-described cure conditions is a polyester (such as polyethylene terephthalate, polyethylene naphthalate, polybutylene terephthalate, or polybutylene naphthalate). Polyethylene terephthalate is preferred. It may be possible to adjust processing conditions to achieve effective adhesion with other release layers, for example polyolefin (such as polyethylene, polypropylene, or ethylene-propylene copolymer), polyvinyl alcohol, polyvinylidene chloride, polyvinyl chloride, vinyl chloride-vinyl acetate copolymer, polyvinyl acetate, polyamide, polyimide, cellulose, fluorinated resin, polyether, polystyrene resin (such as polystyrene), polycarbonate, polyether sulfone, or a combination thereof. In an aspect, the substrate includes polyethylene terephthalate.

The foam can be rolled on a drum for storage and optional heating/post-curing, for example at a temperature of 100 to 300° F. (65.6 to 121.1° C.) for 6 to 48 hours. Post-cure is especially useful to lower compression set, eliminate volatile compounds, and complete cure if needed.

The silicone foam obtained from the curable composition of the present disclosure is a compressible silicone foam. The term “foam” as used herein refers to materials having a cellular structure, i.e., a void content. The foams produced by this method have primarily closed cells. For example, the compressible silicone foams can have a closed cell content of at least 50%, or at least 60%. Cell morphology can be characterized, for example, using various microscopy techniques, for example optical microscopy or scanning electron microscopy. The silicone foams can have a thickness of, for example, 1 to 30 millimeters, or 1 to 20 millimeters, or 1 to 15 millimeters, or 1 to millimeters, or 1 to 8 millimeters, or 1.2 to 8 millimeters, or 1.5 to 8 millimeters, or 1.5 to 6 millimeters, or 2.5 to 6 millimeters. The compressible silicone foam can have a density of less than 400 kilograms per cubic meter (kg/m³), for example 150 to less than 400 kg/cm³, or 150 to less than 350 kg/cm³, or 200 to 335 kg/m³, or 250 to 325 kg/m³. The silicone foam can have a void volume content of 5 to 99%, preferably greater than or equal to 30% (i.e., 30 to 99%), based upon the total volume of the foam.

The compressible silicone foams can advantageously maintain their elastic behavior over many cycles of compression deflection over the life of the foam, properties reflected by compressive force deflection and compression set of the foam. Foams with good compression set resistance provide cushioning and maintain their original shape or thickness under loads for extended periods. In an aspect, the silicone foam can have a compression force deflection (CFD) of less than 35 kilopascals (kPa), or 5 to less than 35 kPa, or 10 to 33 kPa, each at 25% deflection. The silicone foam can have a CFD of less than 100 kPa, or 10 to less than 100 kPa, or 10 to 75 kPa, or 20 to 75 kPa, each at 50% deflection. The silicone foam can have a CFD of less than 1000 kPa, or 100 to less than 1000 kPa, or 100 to 800 kPa, or 150 to 800 kPa, each at 80% deflection. Compression force deflection is determined in accordance with ASTM D1056-20.

The silicone foam can have a compression set of 0 to 5%, determined in accordance with ASTM D1056-20 B2.

In an aspect, the compressible silicone foam is used as a single layer for thermal management. Multiple single layers can be stacked, however, and used as a single layer. In an aspect, the thermal management sheet consists essentially of, or consists of the cured compressible foam, for example, a single layer of compressible silicone foam or multiple layers of the compressible silicone foam. Other layers can be used in combination with the compressible silicone foam, for example, a flame retardant layer, a nonporous elastomeric barrier layer, an adhesive layer, or the like, or a combination thereof. However, one advantage of the silicone foam is that a single sheet used alone can be effective without other layers even at thicknesses as low as 1 to 30 mm, or 1 to 20 mm, or 1 to 15 mm, or 1 to 10 mm, or 1 to 8 mm, or 1 to 6 mm.

If used, the flame retardant layer can include a flame retardant inorganic material such as boehmite, aluminum hydroxide, magnesium hydroxide, an intumescent material, or a combination thereof. The intumescent material can include an acid source, a blowing agent, and a carbon source. Each component can be present in separate layers or as an admixture, for example, an intimate admixture. For example, the intumescent material can include an acid source, a blowing agent, and a carbon source. For example, as the temperature reaches a value, for example, of 200 to 280° C., the acidic species (for example, of the polyphosphate acid) can react with the carbon source (for example, pentaerythritol) to form a char. As the temperature increases, for example, to 280 to 350° C., the blowing agent can then decompose to yield gaseous products that cause the char to swell.

The acid source can include, for example, an organic or an inorganic phosphorous compound, an organic or inorganic sulfate (for example, ammonium sulfate), or a combination thereof. The organic or inorganic phosphorous compound can include an organophosphate or organophosphonate (for example, tris(2,3-dibromopropyl)phosphate, tris(2-chloroethyl)phosphate, tris(2,3-dichloropropyl)phosphate, tris(1-chloro-3-bromoisopropyl)phosphate, bis(1-chloro-3-bromoisopropyl)-1-chloro-3-bromoisopropyl phosphonate, polyaminotriazine phosphate, melamine phosphate, triphenyl phosphate, or guanylurca phosphate); an organophosphite ester (for example, trimethyl phosphite, or triphenyl phosphite); a phosphazene (for example, hexaphenoxycyclotriphosphazene); a phosphorus-containing inorganic compound (for example, phosphoric acid, phosphorus acid, a phosphite, urea phosphate, an ammonium phosphate (for example, ammonium monohydrogen phosphate, ammonium dihydrogen phosphate, or ammonium polyphosphate)); or a combination thereof.

The blowing agent can be a physical blowing agent or a chemical blowing agent. In an aspect, the blowing agent can include an agent that decomposes (for example, into smaller compounds such as ammonia or carbon dioxide) at a temperature of greater than or equal to 120° C., for example, at 120 to 200° C., or at 130 to 200° C. The blowing agent can include a dicyandiamide, an azodicarbonamide, a melamine, a guanidine, a glycine, a urea (for example, a urea-formaldehyde resin or a methylolated guanylurca phosphate), a halogenated organic material (for example, a chlorinated paraffin), or a combination thereof. Alternatively, the blowing agent can comprise a physical blowing agent. Exemplary physical blowing agents include hydrogen atom-containing components, which can be used alone or as mixtures with each other or with another type of blowing agent. These blowing agents can be chosen from a broad range of materials, including hydrocarbons, ethers, esters and partially halogenated hydrocarbons, ethers and esters, or the like. Examples of physical blowing agents have a boiling point from −50 to 100° C., or from −50 to 50° C. Among the hydrogen-containing blowing agents are the HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropanc, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluorocthane, (Z)-1,1,1,4,4,4-hexafluoro-2-butene, and pentafluoroethane; the HFE's (halo fluoroethers) such as methyl-1,1,1-trifluorocthylether and difluoromethyl-1,1,1-trifluorocthylether; and the hydrocarbons such as n-pentane, isopentane, and cyclopentane. In an aspect, the blowing agent can comprise carbon dioxide, nitrogen, argon, water, air, nitrogen, and inert gases (such as helium and argon), as well as combinations thereof. In an aspect, the blowing agent can comprise carbon dioxide, for example solid carbon dioxide (i.e., dry ice), liquid carbon dioxide, gaseous carbon dioxide, or supercritical carbon dioxide.

The intumescent material can include a carbon source. The carbon source can include dextrin, a phenol-formaldehyde resin, pentaerythritol (for example, a dimer or trimer thereof), a clay, a polymer (for example, polyamide 6, an amino-poly(imidazoline-amid), or polyurethane), or a combination thereof. The amino-poly(imidazoline-amid) can include repeating amide linkages and imidazoline groups.

The intumescent material can optionally further include a binder. The binder can include an epoxy, a polyurethane, a polysulfide, a polysiloxane, a polysilanylene, or a combination thereof. The binder can be present in the intumescent material in an amount of less than or equal to 50 wt %, or 5 to 50 wt %, or 35 to 45 wt %, based on the total weight of the intumescent material. The binder can be present in the intumescent material in an amount of 5 to 95 wt %, or 40 to 60 wt %, based on the total weight of the intumescent material.

The intumescent material can optionally include a synergistic compound to further improve the flame retardance of the intumescent material. The synergistic compound can include a boron compound (e.g., zinc borate, boron phosphate, or boron oxide), a silicon compound, an aluminosilicate, a metal oxide (e.g., magnesium oxide, ferric oxide, or aluminum oxide hydrate (boehmite)), a metal salt (e.g., alkali metal or alkaline earth metal salts of organosulfonic acids or alkaline earth metal carbonates), or a combination thereof. Synergistic combinations can include phosphorus-containing compounds with at least one of the foregoing.

The flame retardant layer can further include a char-forming agent, for example, a lignin, boehmite, clay nanocomposite, expandable graphite, pentaerythritol, cellulose, nanosilica, ammonium polyphosphate, lignosulfonate, melamine, cyanurate, zinc borate, huntite, hydromagnesite, or a combination thereof. Without being bound by theory, similar to the intumescent material, it is believed that the char-forming agent can reduce the spread of flames using two energy absorbing mechanisms, including forming a char and then swelling the char.

The flame retardant layer can further include a polymer binder, for example, a silicone, a polyurethane, an ethylene-vinyl acetate, an ethylene-methyl acrylate, an ethylene-butyl acrylate, or a combination thereof. The flame retardant layer can have a thickness of 0.1 to 2 mm, 0.5 to 1.5 mm, or 0.8 to 1.1 mm.

If used, the nonporous elastomeric barrier layer includes an elastomer having a permeability coefficient for water of less than 20 g-mm per m² per day, or less than 10 g-mm per m² per day, or less than 5 g-mm per m² per day, each measured at 25° C. and 1 atmosphere; or a tensile stress at 100% elongation of 0.5 to 15 megaPascals measured at 21° C. in accordance with ASTM 412; or a combination thereof. The nonporous elastomeric barrier layer can have a thickness of 0.25 to 1 mm or 0.4 to 0.8 mm.

The nonporous elastomeric barrier layer can include an elastomeric material that is hydrophobic, to prevent water or water vapor transmission. For example, the elastomeric barrier layer can include a thermoplastic elastomer (TPE), provided that it has a desirable hydrophobicity (lack of water or water vapor transmission). Classes of TPEs include styrenic block copolymers (TPS or TPE-s), (TPO or TPE-o), thermoplastic vulcanizates (TPV or TPE-v), thermoplastic polyurethane, thermoplastic copolyesters (TPC or TPE-E), thermoplastic polyamides (TPA or TPE-A), and others.

Examples of elastomeric materials that can be used include an acrylic rubber, butyl rubber, halogenated butyl rubber, copolyester, epichlorohydrin rubber, ethylene-acrylic rubber, ethylene-butyl acrylic rubber, ethylene-diene rubber (EPR) such as ethylene-propylene rubber, ethylene-propylene-diene monomer rubber (EPDM), ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer (TPU), silicone rubber, fluorinated silicone rubber, styrene-butadiene, styrene-isoprene, vinyl rubber, or a combination thereof. In an aspect the nonporous elastomeric barrier layer includes ethylene-propylene-diene monomer rubber, polychloroprene, or a combination thereof.

An adhesive layer can be present to adhere a thermal management sheet including the silicone foam to another thermal management sheet, another type of layer, or to a component of the cell array or batter. A wide variety of suitable adhesives can be used in the thermal management sheet. The adhesive can be selected for case of application and stability under the operating conditions of the battery. Each adhesive layer can the same or different, and can be of the same or different thickness. Suitable adhesives include a phenolic resin, an epoxy adhesive, a polyester adhesive, a polyvinyl fluoride adhesive, an acrylic or methacrylic adhesive, or a silicone adhesive, preferably an acrylic adhesive or a silicone adhesive. In an aspect, the adhesive is a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

When the thermal management sheet includes an adhesive layer, the thermal management sheet can further include a release layer. By “release layer” is meant any layer including a release coating, optionally supported by one or more additional layers including a release liner. The thickness of each of the release layers can be 5 to 150 micrometers (μm), 10 to 125 μm, 20 to 100 μm, 40 to 85 μm, or 50 to 75 μm.

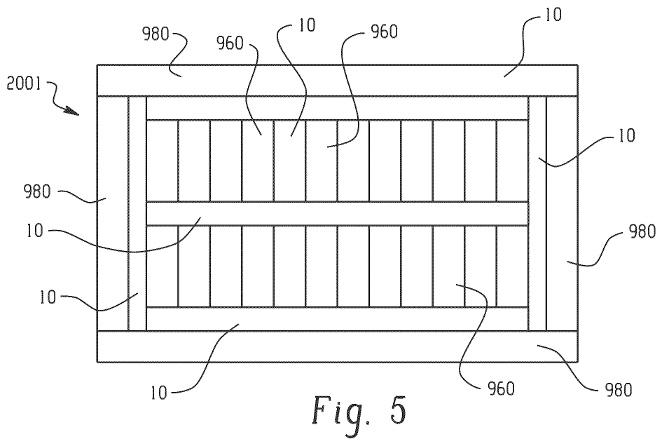

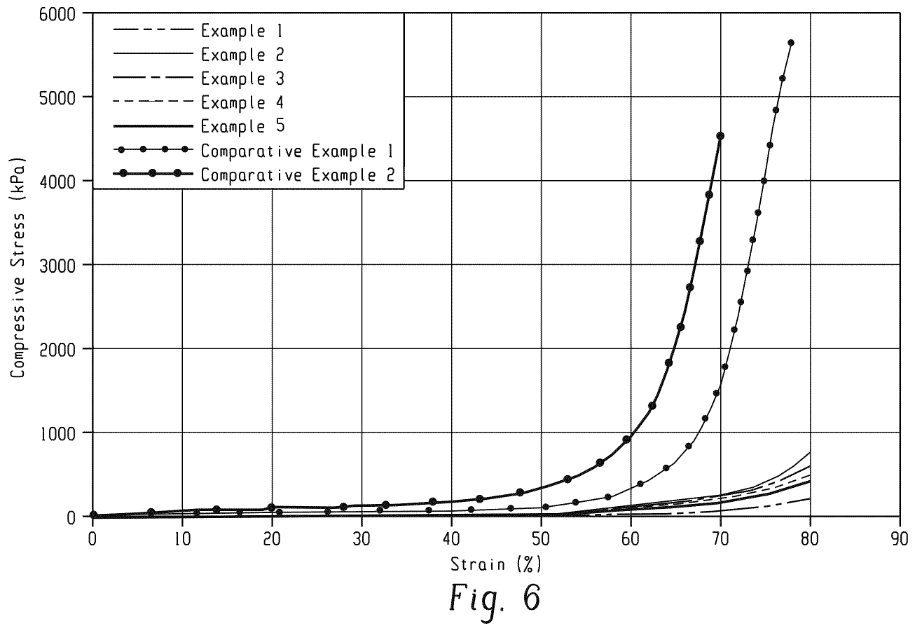

The compressible silicone foam of the present disclosure can be especially useful for assemblies for batteries or battery components (for example, a wall of a battery case). Accordingly, another aspect of the present disclosure is an assembly for a battery comprising a thermal management sheet comprising the compressible silicone foam disposed on a surface of an electrochemical cell. The cells can be lithium-ion cells, in particular, prismatic, cylindrical, or pouch cells. FIG. 2 illustrates an aspect of the positioning of the compressible silicone foam in a cell assembly 1002 and FIG. 3 illustrates another aspect of the positioning of the compressible silicone foam in a cell assembly 1003. FIG. 2 and FIG. 3 illustrate that the thermal management sheet 10 can be located between a first cell 103 and a second cell 104. FIG. 2 illustrates that the thermal management sheet 10 can be approximately the same size as the height and width of the cells 103, 104. FIG. 3 illustrates that the thermal management sheet 10 can be smaller than the respective cells 103, 104. Also as shown in FIG. 3 it is also possible for the thermal management sheet 10 to extend past an edge of an electrochemical cell 103, 104. A thermal management sheet comprising the compressible silicone foam extending past an edge of an electrochemical cell can wrap around and cover at least another portion or all of another surface of the cell.

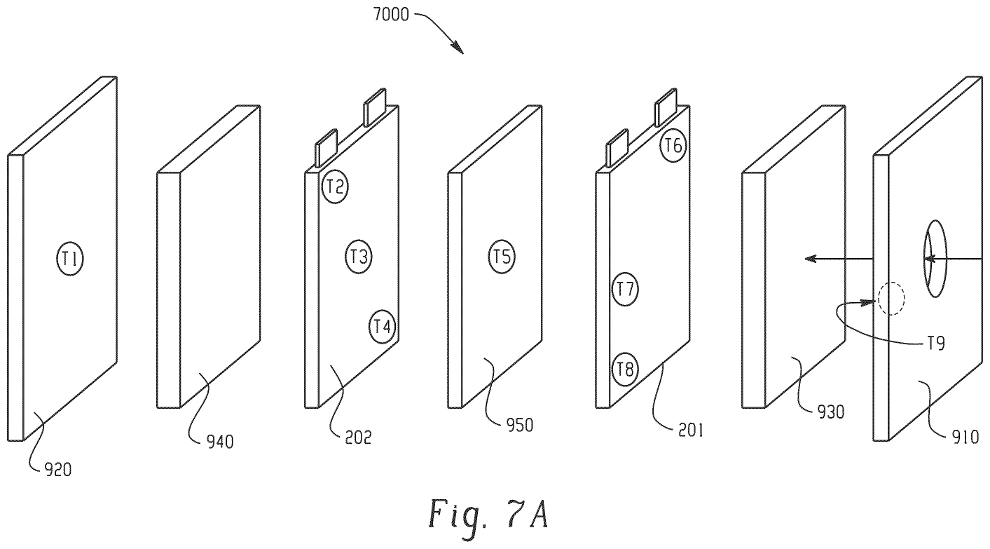

FIG. 4 illustrates that multi-cell arrangement 1004 can include more than two cells 103, 104 with thermal management sheet 10 located in between the respective cells 103, 104. The cells can be lithium-ion cells, in particular pouch cells. FIG. 4 illustrates that an assembly 1004 for a battery can comprise more than two cells (e.g., 103, 104) with thermal management sheet 10 located in between the respective cells 103, 104 and each of the other cells. In an aspect, two to ten compressible silicone foam sheets can be disposed on a cell or in a cell array during manufacture of the assembly 1004 for a battery. For example, two to ten compressible silicone foam sheets can be disposed on the interior, e.g., facing the electrodes, or exterior, facing outside of the battery. Two to ten fire-resistant compressible silicone foam sheets can be disposed on or adhered to a cell or pouch of a pouch cell, or both. Of course, one or more than ten of the compressible silicone foam sheets can be present depending on the number of cells and cell arrays. FIG. 4 further illustrates thermal management sheet 10a disposed on an exterior of assembly 1004 for a battery, to face outside of a battery.

In an aspect, at least a portion of an exposed outer edge of the thermal management sheet comprising the compressible silicone foam can comprise a material 88 that pulls heat away from the body of the thermal management sheet, as shown in FIG. 4. Exemplary materials to apply to an exposed edge of the compressible silicone foam include ceramics such as boron nitride or aluminum nitride, a metal such as aluminum, a high heat capacity wax, a phase change material, or the like, or a combination thereof.

The cell assemblies are used in batteries. A battery includes a housing that at least partially encloses one or more electrochemical cells or cell arrays. The housing can be of any type, for example a polymer or a pouch of a pouch cell. The thermal management sheet can be disposed on or disposed directly on a cell or cell array in any configuration in the battery. The thermal management sheet can be placed between individual cells or cell arrays in the battery. The compressible silicone foam can be placed on, e.g., at the top, in between, below, adjacent, or a combination thereof the sides of the cells or cell arrays in the battery, a portion thereof, or a selected set of cells or cell arrays in the battery. The compressible silicone foam can be placed or adhered to a plurality of pouch cells, pressure management pads, cooling plates, or other interior battery components. The assembly pressure of the battery can hold stacked components into place.

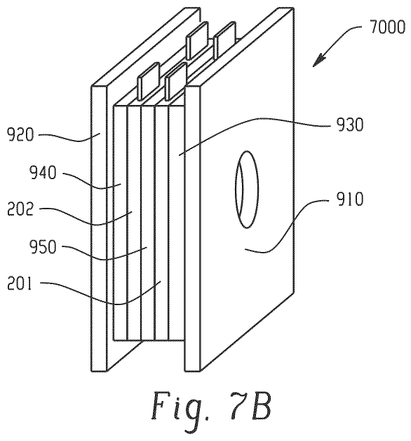

For example, as shown in FIG. 5, a battery 2001 can contain a plurality of cells in a plurality of cell arrays 960 inside a housing 980. The thermal management sheet 10 can be disposed between two cell arrays 960. Further as shown in FIG. 5 the thermal management sheet 10 can be disposed between a side of housing 980 and a side of a cell array 960, along a plurality of the cells of the cell array. Also as shown in FIG. 5, the thermally insulating thermal management sheet 10 can be disposed between an end of housing 980 and an end of one or more cell arrays 960.

If more than one compressible silicone foam sheet or other layer is used, the sheets and layers can be assembled by methods known in the art. The sheets and layers can be assembled on a surface of a cell or other component of a battery (for example, a wall of a battery case). In an aspect, the sheets and layers are assembled separately, and then placed or adhered to the cell, the battery component, or both. Each of the sheets or layers can be manufactured separately, and then stacked (placed or adhered using, for example, one or more adhesive layers) in the desired order. Alternatively, one or more individual layers can be manufactured on another individual layer, for example by coating, casting, or laminating using heat and pressure. For example, in an aspect, a flame retardant layer or an adhesive layer can be directly cast onto the compressible silicone foam. Direct coating or casting can decrease thickness and improve flame retardance by eliminating an adhesive layer.

The following examples are provided to illustrate the present disclosure. The examples are merely illustrative and are not intended to limit devices made in accordance with the disclosure to the materials, conditions, or process parameters set forth therein.

### EXAMPLES

Materials used in the following examples are described in Table 1.

TABLE 1

| Component | Description | Supplier |
|---|---|---|
| Polyorganosiloxane A | Vinyl-terminated polydimethylsiloxane, having a viscosity of | Elkem |
| | 100,000 cP, a degree of polymerization of 1850-1900, and a vinyl | |
| | content of 0.04 wt %, obtained as BLUESIL FLD47 | |
| Polyorganosiloxane B | Vinyl-terminated polydimethylsiloxane, having a viscosity of 200 | Gelest |
| | cP, a degree of polymerization of 110-150, and a vinyl content of 0.5 | |
| | wt %, obtained as DMS-V22 | |
| Polyorganosiloxane C | Monovinyl-terminated polydimethylsiloxane having a vinyl content | Gelest |
| | of 0.15 wt %, a viscosity of 500 cP, and a degree of polymerization | |
| | of 230-240, obtained as MCR-V25 | |
| Polyorganosiloxane D | MQ polydimethylsiloxane having pendent vinyl groups in a vinyl- | Elkem |
| | terminated polydimethylsiloxane carrier (25:75 by weight), having a | |
| | vinyl content of 1 wt % and a viscosity of 15,000 cP, obtained as | |
| | BLUESIL 11342 | |
| Polyorganosiloxane E | Vinyl-terminated polydimethylsiloxane copolymer having pendent | Elkem |
| | vinyl groups, having a vinyl content of 2.5 wt %, a viscosity of 390 | |
| | cP, and approximately 5% of the repeating units bearing a vinyl | |
| | functionality, obtained as BLUESIL FLD 50620W | |
| Polyorganosiloxane F | Hydroxyl terminated polydimethylsiloxane, having a viscosity of | Elkem |
| | 750 cP and a hydroxyl content of 0.22 wt %, obtained as BLUESIL | |
| | FLD 48V750 | |
| Polyorganosiloxane G | Trimethyl terminated MeHSiO siloxane polymer having a hydride | Elkem |
| | content of 1.5 wt %, a viscosity of 25 cP, obtained as WR-68, in a | |
| | vinyl-terminated polydimethylsiloxane carrier, having a vinyl | |
| | content of 0.32 wt % and a viscosity of 1000 cP, obtained as | |
| | BLUESIL FLDV1000 (40:60 weight ratio of trimethyl terminated | |
| | MeHSiO siloxane polymer:carrier) | |
| Polyorganosiloxane H | Hydride terminated polydimethyl siloxane, having a hydride weight | Gelest |
| | percent of 0.04% and a viscosity of 100 cP, obtained as DMS-H21 | |
| Polyorganosiloxane I | Methylhydrosiloxane-dimethylsiloxane copolymer, having a hydride | Gelest |
| | weight percent of 0.03%, a viscosity of 7500 cP, and approximately | |
| | 7% of the repeating units bearing a hydride functionality, obtained as | |
| | HMS-064 | |
| Polyorganosiloxane J | α-Monovinyl-Ω-monohydride terminated polydimethylsiloxane | Gelest |
| | having a hydride weight percent of 0.01%, a vinyl weight percent of | |
| | 0.27%, and a viscosity of 200 cP, obtained as DMS-HV22 | |
| DI water | Deionized Water | |
| BuOH | 1-Butanol | |
| BzOH | Benzyl alcohol | |
| ATH | Aluminum trihydrate, having a mean particle size of 1-5 | |
| | micrometers, obtained as MICRAL 855 | |
| ZB | Zinc borate, having a mean particle size of 9 micrometers, obtained | |
| | as FIREBRAKE ZB | |
| Pt Catalyst | [1,3-Bis(2,6-diisopropylphenyl)imidazol-2-ylidene][1,3-divinyl- | Umicore |
| | 1,1,3,3-tetramethyldisiloxane]platinum(0), obtained as Umicore | |
| | HS245 Pt catalyst solution (10%) | |
| Inhibitor | Vinyl diterminated dimethyl siloxane, having a vinyl content of 29 | Dow Chemical |
| | wt % and a molecular weight of 186 g/mol, obtained as DOWSIL 4- | Co. |
| | 2776 | |

The following general mixing protocol was used to prepare the foam of the present examples.

A first foam precursor mixture (“Part A”) was prepared by adding polyorganosiloxane A-F, blowing agent (i.e., DI water, BuOH, BzOH) Pt catalyst, and inhibitor to a mixing cup. The mixture was mixed in a FlackTek speedmixer at 2000 revolutions per minute (rpm) for 30 seconds(s). To this mixture, the filler (ATH, ZB) was added in sequence. The mixture was mixed in the speedmixer according to the following protocol: 2100 rpm for 8 s, 2300 rpm for 8 s, 2500 rpm for 10 s, 2650 rpm for 8 s, and 2750 rpm for 8 s. After mixing, the cup was removed and cooled to 40° F. (4.4° C.).

A second foam precursor mixture (“Part B”) was provided comprising polyorganosiloxane G-J. The first and second foam precursor mixtures were combined in particular weight ratios to obtain a foam. For example, the first foam precursor mixture and the second foam precursor mixture were combined in the desired weight ratio. After manually mixing the two components thoroughly for 35 s, the mixed composition was dispensed as quickly as possible on a thin polyethylene terephthalate (PET) sheet (4 mil (0.1016 millimeters (mm))) and drawn between rollers having a nip gap set at 25 mil (0.025 inches (in); 0.635 mm). The resulting foam sandwiched between the two PET films was placed in a convection oven set at 90° C. for 3 minutes and then additionally for 2 minutes for further progressing the cure. After a total of 5 minutes, the cast foam was peeled off from the backing PET films. The thickness of the foam was then measured, and expansion was calculated according to the following formula: expansion=(final thickness of the foam)/((nip gap)−(thickness of PET film)). After 24 hours (h), the delaminated foam sheet was placed in convection oven set at 100° C. for 24 h for post-curing. Post-cured foam was then characterized for density, compression deflection (25%, 50%, and 80%), and compression set (22 h, 100° C.) (ASTM D1056-20 B2). Flammability was characterized according to UL-94. Samples achieving a rating of V0 are characterized as “Pass” in Table 2.

The amounts of the components used to prepare the foam for each example are provided in Table 2 in both weight percent based on the total weight of the first foam precursor mixture (“Part A”) or weight percent based on the total weight of second foam precursor mixture (“Part B”), and in grams (g). Table 2 also shows the characterization of each foam example.

TABLE 2

| | | | | | | | | | | | |
|---|---|---|---|---|---|---|---|---|---|---|---|
| Component | Units | CE1 | CE2 | CE3 | E1 | E2 | E3 | E4 | E5 | CE4 | CE5 |

Part A

| | | | | | | | | | | | |
|---|---|---|---|---|---|---|---|---|---|---|---|
| Polyorgano- | wt % | 49.8 | 49.8 | 49.8 | 64 | 47 | 46.3 | 44.1 | 47.1 | 41.2 | 47.1 |
| siloxane A | (g) | (100) | (100) | (100) | (100) | (100) | (100) | (100) | (100) | (100) | (100) |
| Polyorgano- | wt % | | | | | | | 1.3 | | 2.4 | |
| siloxane B | (g) | | | | | | | (2.93) | | (5.86) | |
| Polyorgano- | wt % | | | | | | 1.2 | 2.2 | | 4.1 | |
| siloxane C | (g) | | | | | | (2.48) | (4.97) | | (10) | |
| Polyorgano- | wt % | | | | 2.1 | 1.5 | 1.2 | 1.1 | 1.5 | 1.1 | 1.5 |
| siloxane D | (g) | | | | (3.2) | (3.2) | (2.6) | (2.6) | (3.2) | (2.6) | (3.2) |
| Polyorgano- | wt % | | | | 1.0 | 0.8 | 0.7 | 0.7 | 0.8 | 0.7 | 0.8 |
| siloxane E | (g) | | | | (1.6) | (1.6) | (1.58) | (1.58) | (1.6) | (1.58) | (1.6) |
| Polyorgano- | wt % | | | | 0.5 | 0.4 | 0.4 | 0.3 | 0.4 | 0.3 | 0.4 |
| siloxane F | (g) | | | | (0.85) | (0.85) | (0.78) | (0.78) | (0.8) | (0.78) | (0.8) |
| DI water | wt % | | | | 0.1 | 0.1 | 0.1 | 0.1 | 0.1 | 0.1 | 0.1 |
| | (g) | | | | (0.16) | (0.16) | (0.16) | (0.16) | (0.16) | (0.16) | (0.16) |
| BuOH | wt % | | | | 0.20 | 0.2 | 0.1 | 0.1 | 0.2 | 0.1 | 0.2 |
| | (g) | | | | (0.31) | (0.31) | (0.3) | (0.3) | (0.31) | (0.3) | (0.31) |
| BzOH | wt % | 0.4 | 0.4 | 0.4 | | | | | | | |
| | (g) | (0.784) | (0.602) | (0.865) | | | | | | | |
| ATH | wt % | 19.9 | 19.9 | 19.9 | 12.8 | 20 | 20 | 20 | 20 | 20 | 20 |
| | (g) | (40) | (40) | (40) | (20) | (42.53) | (43.11) | (45.28) | (42.51) | (48.58) | (42.51) |
| ZB | wt % | 29.9 | 29.9 | 29.9 | 19.2 | 30 | 30 | 30 | 30 | 30 | 30 |
| | (g) | (60) | (60) | (60) | (30) | (63.8) | (64.66) | (67.92) | (63.7) | (72.87) | (63.7) |
| Pt Catalyst | wt % | 0.01 | 0.01 | 0.01 | 0.01 | 0.01 | 0.01 | 0.01 | 0.01 | 0.01 | 0.01 |
| | (g) | (0.0248) | (0.017) | (0.0248) | (0.025) | (0.026) | (0.0212) | (0.0214) | (0.025) | (0.02145) | (0.025) |
| Inhibitor | wt % | 0.08 | 0.08 | 0.08 | 0.13 | 0.09 | 0.07 | 0.07 | 0.09 | 0.07 | 0.09 |
| | (g) | (0.16) | (0.16) | (0.16) | (0.2) | (0.2) | (0.16) | (0.16) | (0.2) | (0.16) | (0.2) |

Part B

| | | | | | | | | | | | |
|---|---|---|---|---|---|---|---|---|---|---|---|
| Polyorgano- | wt % | 100 | 100 | 100 | 100 | 100 | 90.6 | 83.5 | 69.8 | 84.4 | 53.6 |
| siloxane G | (g) | (11.165) | (11.154) | (11.169) | (8.685) | (11.816) | (11.975) | (12.577) | (13.49) | (11.805) | (11.805) |
| Polyorgano- | wt % | | | | | | 8.4 | 14.8 | | 14 | |
| siloxane H | (g) | | | | | | (1.115) | (2.23) | | (2.23) | |
| Polyorgano- | wt % | | | | | | 0.98 | 1.73 | | 1.63 | |
| siloxane I | (g) | | | | | | (0.13) | (0.26) | | (0.26) | |
| Polyorgano- | wt % | | | | | | | | 30.2 | | 46.4 |
| siloxane J | (g) | | | | | | | | (5.1) | | (10.2) |

Processing

| | | | | | | | | | | | |
|---|---|---|---|---|---|---|---|---|---|---|---|
| Part | wt; wt | 18:1 | 18:1 | 18:1 | 18:1 | 18:1 | 16:1 | 15:1 | 15:1 | 12.5:1 | 9.6:1 |
| A:Part B | | | | | | | | | | | |
| Molar ratio | mol/mol | 1.6 | 1.61 | 1.57 | 1.2 | 1.2 | 1.3 | 1.25 | 1.31 | 1.19 | 1.17 |
| of hydride | | | | | | | | | | | |
| groups to | | | | | | | | | | | |
| (vinyl + | | | | | | | | | | | |
| hydroxyl) | | | | | | | | | | | |
| groups | | | | | | | | | | | |

Properties

| | | | | | | | | | | | |
|---|---|---|---|---|---|---|---|---|---|---|---|
| Thickness | mm | 3 | 3 | — | 3.1 | 3.2 | 3.2 | 3.2 | 3.4 | — | — |
| Density | kg/m³ | 400 | 400 | — | 272 | 310 | 300 | 315 | 275 | — | — |
| CFD at 25% | kPa | 25 | 114 | — | 12.3 | 31.4 | 24.1 | 24.9 | 23.4 | — | — |
| CFD at 50% | kPa | 117 | 351 | — | 33.6 | 66.3 | 51 | 66.6 | 64.4 | — | — |
| CFD at 80% | kPa | 5500 | 4560¹ | — | 231 | 776 | 597 | 488 | 444 | — | — |
| Compression | % | <5 | <5 | — | 2.3 | 1.4 | 1.6 | 1.2 | 2.6 | — | — |
| Set | | | | | | | | | | | |
| UL-94 V0 | | Pass | Pass | — | Pass | Pass | Pass | Pass | Pass | — | — |

¹CFD at 70%

Comparative examples 1-3 included only polyorganosiloxane A (in Part A) and polyorganosiloxane G (in Part B) and none of polyorganosiloxane B—F (in Part A) or H-J (in Part B). Comparative examples 4 and 5 had a molar ratio of hydride groups to a sum of vinyl and hydroxyl groups of 1.17-1.19, and examples 1-5 had a molar ratio of hydride groups to a sum of vinyl and hydroxyl groups of 1.2 to 1.31.

The composition according to comparative example 3 could not provide a cast foam. The composition according to comparative examples 4 and 5 resulted in a sticky, foamed material that could not be removed from the backing layer. Accordingly, characterization of the compositions according to comparative examples 4 and 5 was not carried out. The compositions according to comparative examples 1 and 2 provided foams, but exhibited high CFD values, even at 25%. As will be further discussed below, the foams according to the present disclosure demonstrated desirable thermal properties. Thus, the foams according to the present disclosure can provide extremely soft and compressible materials, while also maintaining desirable thermal properties.

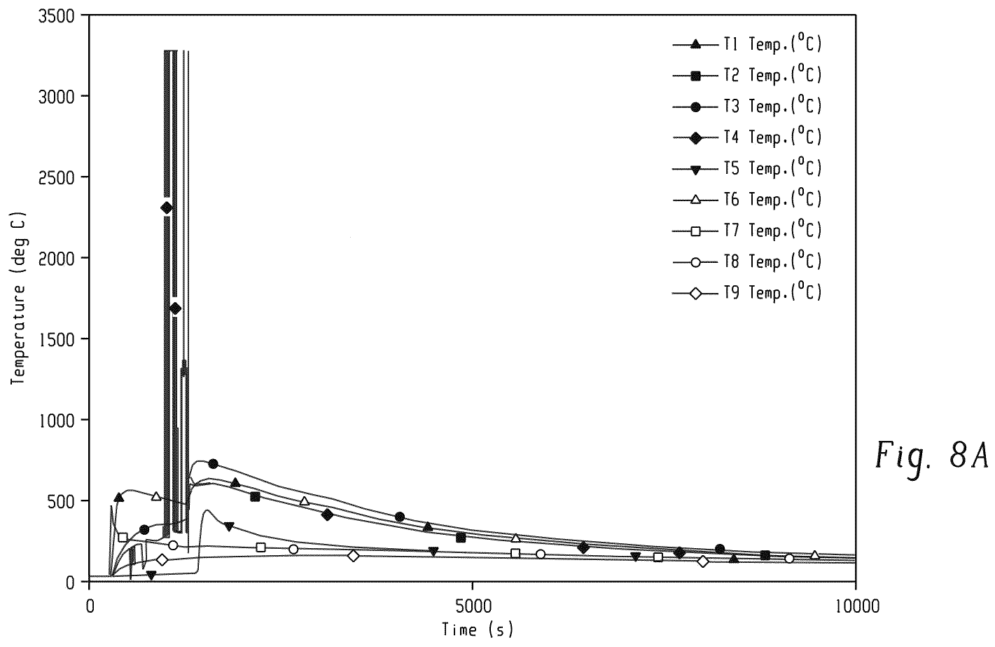

In contrast, the compositions according to examples 1 to 5 yielded cast foams which were highly compressible and flame retardant. FIG. 6 is a graph of the compressive force deflection for comparative examples 1 and 2 and examples 1 to 5. As shown in FIG. 6, the foams of comparative examples 1 and 2 exhibited high compressive stress as strain increased. In contrast, the foams of examples 1 to 5 maintained lower compressive stresses (e.g., less than 1,000 kPa) even at strains greater than 70%. Furthermore, as shown in FIG. 6, the foams according to examples 1 and 2 begin to exhibit a large increase in observed compressive stress between 60 and 70% strain. In contrast, the foams according to each of examples 1-5 according to the present disclosure did not exhibit the same dramatic upturn in compressive stress over the strains tested (i.e., up to 80%). The combination of low compressive stress and a delayed onset of an observed increase in compressive stress represents a significant advantage in highly filled foams.

### Nail Penetration Testing

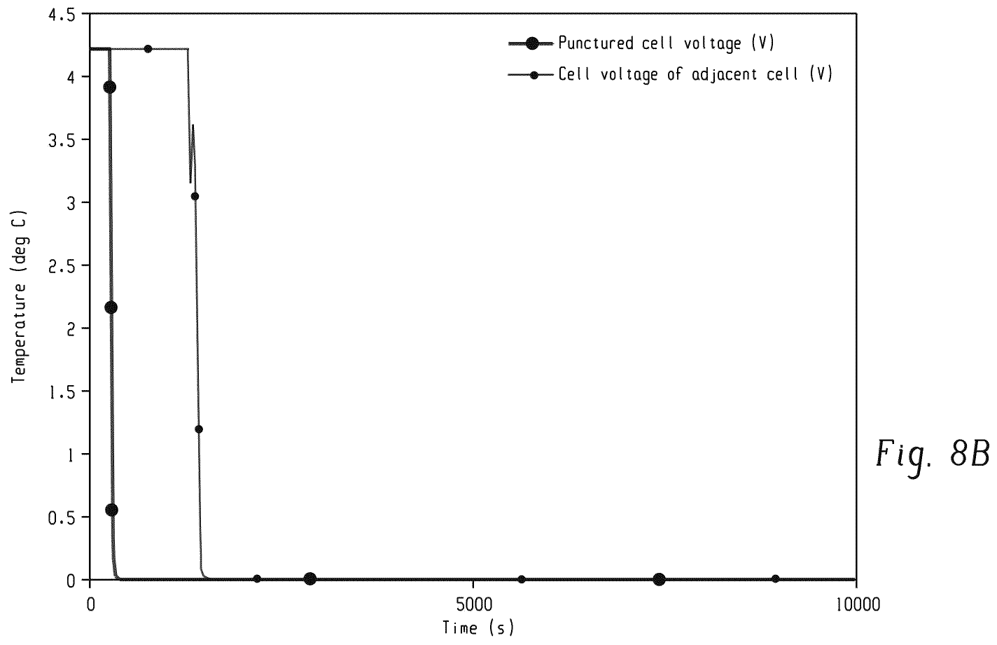

Nail penetration testing was performed. FIG. 7A and FIG. 7B are exploded and non-exploded views, respectively, of a schematic of a first apparatus 7000 for the nail penetration testing, including aluminum end plates 910, 920 (having dimensions of 185 mm×90 mm×15.2 mm), insulation film 930, 940 (having dimensions of 185 mm×90 mm×1 mm), pouch cells 201, 202, and the sample 950 tested. Characteristics of the cells 201, 202 are provided in Table 3. Cell 201 was punctured by an 8 mm nail inserted at an indentation rate of 10 millimeters per second (mm/s) to initiate runaway. The cells 201, 202 were electrically isolated. Multiple thermocouples (T1-T9) measured the temperature profile. Voltage was also measured.

TABLE 3

| | |
|---|---|
| Cell information | Hi Power Polymer Li-Ion (nickel manganese |
| | cobalt (NMC) Pouch) |
| Capacity | 10 ampere-hour (Ah) |
| Voltage | 3.7 volts (V) (standard); 4.2 V (charging) |
| Dimensions (L × W × H) | 100 mm × 150 mm × 3 mm |
| Weight | 1.18 kg |

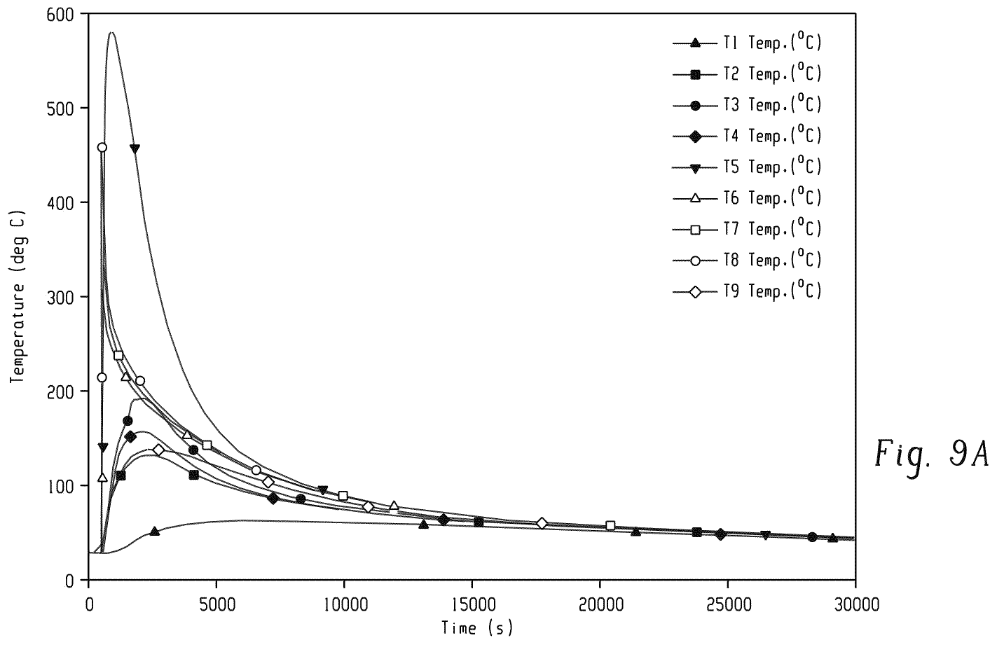

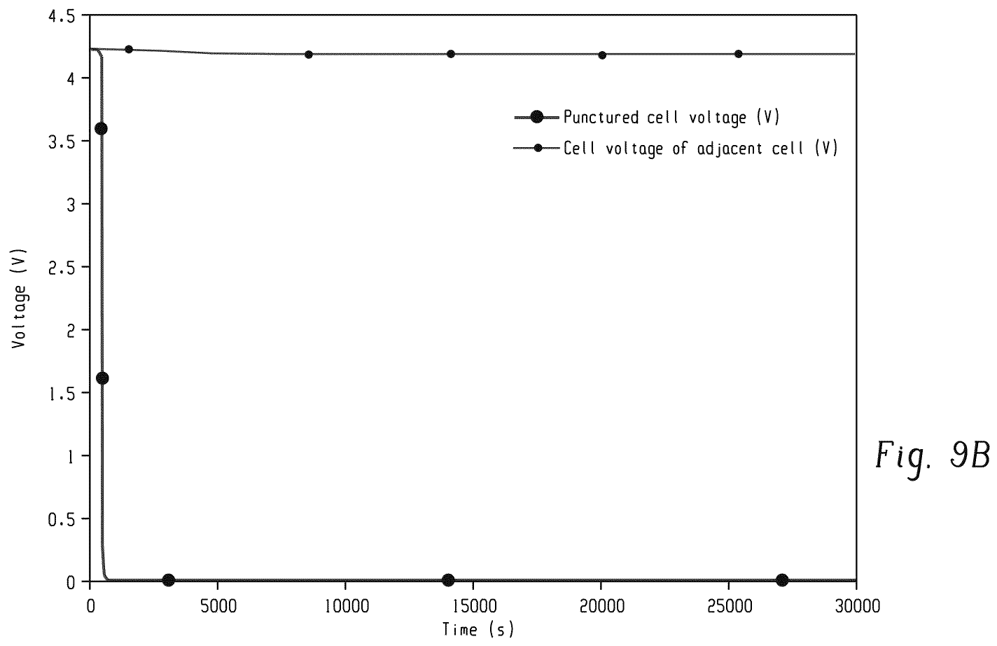

Results of the nail penetration testing of comparative example 2 and example 2 (at two thicknesses) are shown in Table 4 and FIGS. 8 to 9.

TABLE 4

| Sample | CE2 | E2 | |
|---|---|---|---|
| Thickness (mm) | 3.126 | 1.36 | 3.47 |
| Sample dimension | 150 mm × 300 | 100 mm × 150 | 100 mm × 150 |
| (L × w) | mm | mm | mm |
| Maximum | Nail cell: 708.8; | Nail cell: 627; | Nail cell: 583; |
| temperature (° C.) | Neighbor | Neighbor | Neighbor |
| | cell: 737.9 | cell: 1367 | cell: 191 |
| Delay based on | >7,000 | 90 | >50,000 |
| voltage (s) | | | |

FIGS. 8a and 8b are graphs of temperature (C) or voltage (volts (V)), respectively, versus time (seconds(s)) showing results of the nail penetration testing of example 2 at a thickness of 1.36 mm. Results show a 90 second delay for example 2 at 1.36 mm thickness. FIGS. 9a and 9b are graphs of temperature (° C.) or voltage (volts (V)), respectively, versus time(s) showing results of the nail penetration testing of example 2 at a thickness of 3.47 mm. Notably, a delay of greater than 50,000 seconds was observed for example 2, and a delay of greater than 7,000 seconds was observed for comparative example 2 at similar thicknesses (e.g., 3.1-3.5 mm), as shown in International Publication No. WO 2022/192213, the contents of which is hereby incorporated by reference in its entirety. Thus, the foams according to the present disclosure can provide extremely soft and compressible materials, while also maintaining desirable thermal properties, providing a delay or preventing thermal runaway. Advantageously, even a significantly thinner foam can provide a delay in thermal runaway compared to previous materials. The added compressibility of the present foams can advantageously provide reduced stress on battery cells, enabling longer lifetimes and enhanced safety (e.g., reduced leakage due to pressure exerted by the foam). The particular materials described herein can therefore provide a unique combination of properties not obtainable with previous materials.

### Thermal Testing

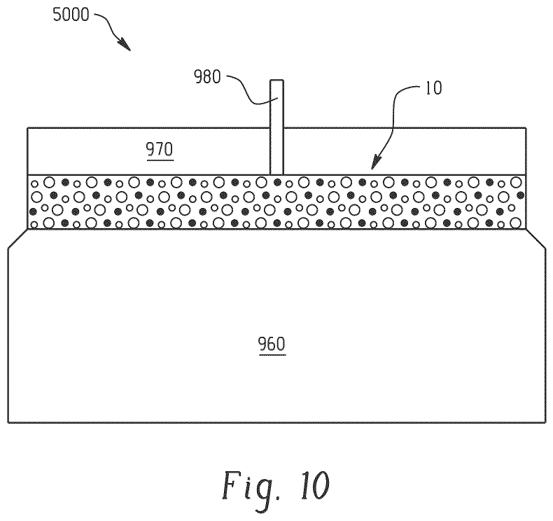

Thermal performance of various samples was determined in a thermal runaway simulation. FIG. 10 illustrates the apparatus 5000 used for thermal testing. A thermal management sheet 10 was disposed directly on hot plate 960 set to 550° C. The foam was placed on the hotplate. A 12.7 mm stainless steel plate cell analog 970 was placed on the top surface of the thermal management sheet 10. A thermocouple sensor 980 was inserted into a hole drilled in the mica plate analog 970 to dispose the thermocouple sensor 980 on the top surface of the thermal management sheet 10.

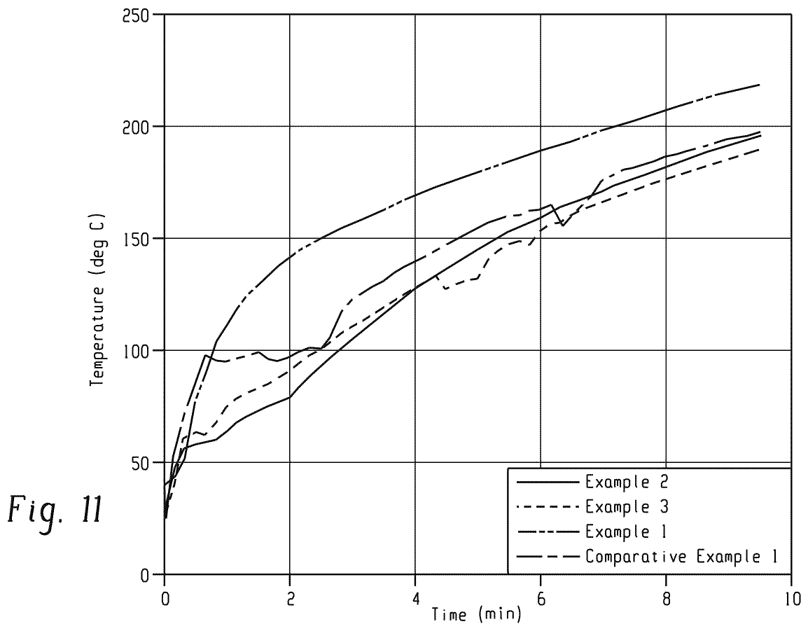

FIG. 11 shows the temperature increase detected by the thermocouple for each sample measured over time. Advantageously, examples 1-3 as well as comparative example 1 demonstrated desirable thermal barrier properties. Thus, the foams according to the present disclosure can provide extremely soft and compressible materials, while also maintaining desirable thermal properties. The particular materials described herein can therefore provide a unique combination of properties not obtainable with previous materials.

A significant improvement is therefore provided by the present disclosure.

This disclosure further encompasses the following aspects.

Aspect 1: A curable composition for preparing a compressible silicone foam comprising: an alkenyl-containing component comprising, based on the total weight of the curable composition: 30 to 75 weight percent of an alkenyl-diterminated polyorganosiloxane; 0.5 to 5 weight percent of an alkenyl-substituted MQ polyorganosiloxane; 0.1 to 5 weight percent of an alkenyl-substituted copolyorganosiloxane; and a hydride-containing component comprising a hydride-substituted polyorganosiloxane; a cure catalyst; a filler composition; and a blowing agent.

Aspect 2: The curable composition of aspect 1, wherein the filler composition comprises: a first filler that decomposes to generate water upon initial exposure to heat; and a second filler different from the first filler, wherein the second filler forms a thermal barrier layer with a decomposition product of the first filler, or absorbs the water, or both.

Aspect 3: The curable composition of aspect 2, wherein the first filler and the second filler are at least two of aluminum trihydrate, ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or waterglass.

Aspect 4: The curable composition of aspect 3, wherein the first filler comprises aluminum trihydrate, hydrous sodium silicate, magnesium carbonate hydroxide pentahydrate, magnesium phosphate tribasic octahydrate, a superabsorbent polymer, waterglass, or a combination thereof.

Aspect 5: The curable composition of aspect 3 or 4, wherein the second filler comprises ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or a combination thereof.

Aspect 6: The curable composition of any of aspects 1 to 5, wherein the filler composition comprises aluminum trihydrate and zinc borate.

Aspect 7: The curable composition of any of aspects 1 to 6, wherein the alkenyl-diterminated polyorganosiloxane comprises a vinyl-diterminated polydimethysiloxane, preferably having a viscosity of greater than 10,000 centipoise, preferably a viscosity of 50,000 to 150,000 centipoise.

Aspect 8: The curable composition of any of aspects 1 to 6, wherein the alkenyl-diterminated polyorganosiloxane comprises a first alkenyl-diterminated polyorganosiloxane, preferably comprising a first vinyl-diterminated polydimethysiloxane having a viscosity of greater than 10,000 centipoise, preferably a viscosity of 50,000 to 150,000 centipoise; and a second alkenyl-diterminated polyorganosiloxane, preferably comprising a second vinyl-diterminated polydimethysiloxane having a viscosity of less than or equal to 10,000 centipoise, preferably a viscosity of 100 to 500 centipoise.

Aspect 9: The curable composition of any of aspects 1 to 8, wherein the alkenyl-substituted copolyorganosiloxane comprises a vinyl-diterminated polydimethylsiloxane comprising vinyl pendent groups, preferably having a viscosity of less than 1,000 centipoise, preferably 100 to 500 centipoise.

Aspect 10: The curable composition of any of aspects 1 to 9, wherein the cure catalyst comprises platinum.

Aspect 11: The curable composition of any of aspects 1 to 10, comprising 10 to 70 weight percent, or 20 to 60 weight percent, or 20 to 50 weight percent of the filler composition, based on the total weight of the curable composition.

Aspect 12: The curable composition of any of aspects 1 to 11, wherein the blowing agent comprises: water, a silanol-terminated polyorganosiloxane; and a C₁₋₁₂ monoalcohol.

Aspect 13: The curable composition of any of aspects 1 to 12, wherein the curable composition comprises 0.5 to 2 weight percent of the blowing agent, based on the total weight of the curable composition; preferably wherein the blowing agent comprises: 0.01 to 0.5 weight percent water, 0.1 to 1 weight percent of silanol-terminated polyorganosiloxane, and 0.05 to 0.5 weight percent of C₁₋₁₂ monoalcohol; each based on the total weight of the curable composition.

Aspect 14: The curable composition of any of aspects 12 to 13, wherein the C₁₋₁₂ monoalcohol is butanol.

Aspect 15: The curable composition of any of aspects 1 to 14, further comprising an inhibitor comprising an alkenyl-diterminated polyorganosiloxane having a vinyl content of greater than or equal to 15 weight percent, based on a total weight of the alkenyl-diterminated polyorganosiloxane, a molecular weight of less than 500 grams per mole, or both.

Aspect 16: The curable composition of aspect 15, comprising 0.01 to 0.4 weight percent of the inhibitor, wherein weight percent is based on the total weight of the alkenyl-containing component and the hydride-containing component.

Aspect 17: The curable composition of any of aspects 1 to 16, wherein the alkenyl-containing component of the curable composition further comprises a mono-alkenyl terminated polyorganosiloxane.

Aspect 18: The curable composition of aspect 17, wherein the mono-alkenyl terminated polyorganosiloxane is present in an amount of 0.5 to 5 weight percent, based on the total weight of the curable composition.

Aspect 19: The curable composition of any of aspects 1 to 18, wherein the alkenyl-containing component and the hydride-containing component are present in a weight ratio of alkenyl-containing component: hydride-containing component of 10:1 to 40:1, or 13:1 to 40:1, or 13:1 to 25:1, or 13:1 to 20:1.

Aspect 20: The curable composition of any of aspects 1 to 19, wherein the curable composition comprises a molar ratio of hydride groups to a sum of alkenyl and hydroxyl groups of 1.1:1 to 2.5:1, or 1.1:1 to 2:1, or 1.1:1 to 1.5:1.

Aspect 21: The curable composition of any of aspects 1 to 20, wherein the compressible silicone foam has a thickness of 1 to 30 millimeters, or 1 to 20 millimeters, or 1 to 15 millimeters, or 1 to millimeters, or 1 to 8 millimeters, or 1.2 to 8 millimeters, or 1.5 to 8 millimeters, or 1.5 to 6 millimeters, or 2.5 to 6 millimeters.

Aspect 22: A compressible silicone foam comprising a cured product of the curable composition of any of aspects 1 to 21.

Aspect 23: The compressible silicone foam of aspect 22, wherein the compressible silicone foam has a density of less than 400 kilograms per cubic meter.

Aspect 24: The compressible silicone foam of aspect 22 or 23, wherein the compressible silicone foam has a compression force deflection of less than 35 kilopascals at 25% deflection, a compression force deflection of less than 100 kilopascals at 50% deflection, and a compression force deflection of less than 1000 kilopascals at 80% deflection; wherein compression force deflection is determined in accordance with ASTM D1056-20.

Aspect 25: An assembly for a battery comprising the compressible silicone foam of any of aspects 22 to 24 disposed on a surface of an electrochemical cell, preferably a lithium-ion electrochemical cell.

Aspect 26: The assembly of aspect 25, wherein the electrochemical cell comprises a prismatic cell, a pouch cell, or a cylindrical cell.

Aspect 27: The assembly of aspect 25 or 26, wherein the assembly comprises at least two electrochemical cells.

Aspect 28: A battery comprising: the assembly for a battery of any of aspects 25 to 27; and a housing at least partially enclosing the assembly for a battery.

Aspect 29: A method for forming a compressible silicone foam sheet, the method comprising: casting the curable composition of any of aspects 1 to 21 onto a first release layer; placing a second release layer on a side of the cast curable composition opposite the first release liner to form a multilayer structure; passing the cast curable composition on the substrate through the nip of two rotating rollers to meter the amount of curable composition; and curing the curable composition to form the compressible silicone foam sheet.

Aspect 30: The method of aspect 29, further comprising mixing the alkenyl-containing component and the hydride-containing component to provide the curable composition.

Aspect 31: A compressible silicone foam formed according to the method of aspect 29 or 30.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A curable composition for preparing a compressible silicone foam comprising:
an alkenyl-containing component comprising, based on the total weight of the curable composition:
30 to 75 weight percent of an alkenyl-diterminated polyorganosiloxane;
0.5 to 5 weight percent of an alkenyl-substituted MQ polyorganosiloxane;
0.1 to 5 weight percent of an alkenyl-substituted copolyorganosiloxane; and
a hydride-containing component comprising a hydride-substituted polyorganosiloxane;
a cure catalyst;
a filler composition; and
a blowing agent.

2. The curable composition of claim 1, wherein the filler composition comprises:
a first filler that decomposes to generate water upon initial exposure to heat; and
a second filler different from the first filler,
wherein the second filler forms a thermal barrier layer with a decomposition product of the first filler, or absorbs the water, or both.

3. The curable composition of claim 2,
wherein the first filler comprises aluminum trihydrate, hydrous sodium silicate, magnesium carbonate hydroxide pentahydrate, magnesium phosphate tribasic octahydrate, a superabsorbent polymer, waterglass, or a combination thereof; and
wherein the second filler comprises ammonium nitrate, sodium borate, hydrous sodium silicate, magnesium hydroxide, magnesium carbonate hydroxide pentahydrate, magnesium phosphate tribasic octahydrate, zinc borate, a superabsorbent polymer, or a combination thereof.

4. The curable composition of claim 1, wherein the filler composition comprises aluminum trihydrate and zinc borate.

5. The curable composition of claim 1, wherein the alkenyl-diterminated polyorganosiloxane comprises a vinyl-diterminated polydimethysiloxane having a viscosity of greater than 10,000 centipoise, preferably a viscosity of 50,000 to 150,000 centipoise.

6. The curable composition of claim 1, wherein the alkenyl-diterminated polyorganosiloxane comprises
a first alkenyl-diterminated polyorganosiloxane comprising a first vinyl-diterminated polydimethysiloxane having a viscosity of greater than 10,000 centipoise; and
a second alkenyl-diterminated polyorganosiloxane comprising a second vinyl-diterminated polydimethysiloxane having a viscosity of less than or equal to 10,000 centipoise.

7. The curable composition of claim 1, wherein the alkenyl-substituted copolyorganosiloxane comprises a vinyl-diterminated polydimethylsiloxane comprising vinyl pendent groups.

8. The curable composition of claim 1, wherein the cure catalyst comprises platinum.

9. The curable composition of claim 1, comprising 10 to 70 weight percent of the filler composition, based on the total weight of the curable composition.

10. The curable composition of claim 1, wherein the curable composition comprises 0.5 to 2 weight percent of the blowing agent, based on the total weight of the curable composition,
wherein the blowing agent comprises:
water,
a silanol-terminated polyorganosiloxane; and
a C₁₋₁₂ monoalcohol.

11. The curable composition of claim 1, further comprising 0.01 to 0.4 weight percent of an inhibitor comprising an alkenyl-diterminated polyorganosiloxane having a vinyl content of greater than or equal to 15 weight percent, based on a total weight of the alkenyl-diterminated polyorganosiloxane, a molecular weight of less than 500 grams per mole, or both, wherein weight percent is based on the total weight of the alkenyl-containing component and the hydride-containing component.

12. The curable composition of claim 1, wherein the alkenyl-containing component of the curable composition further comprises 0.5 to 5 weight percent of a mono-alkenyl terminated polyorganosiloxane, based on the total weight of the curable composition.

13. The curable composition of claim 1, wherein the alkenyl-containing component and the hydride-containing component are present in a weight ratio of alkenyl-containing component: hydride-containing component of 10:1 to 40:1.

14. The curable composition of claim 1, wherein the curable composition comprises a molar ratio of hydride groups to a sum of alkenyl and hydroxyl groups of 1.1:1 to 2.5:1.

15. The curable composition of claim 1, wherein the compressible silicone foam has a thickness of 1 to 30 millimeters.

16. A compressible silicone foam comprising a cured product of the curable composition of claim 1, wherein
the compressible silicone foam has a density of less than 400 kilograms per cubic meter;
the compressible silicone foam has a compression force deflection of less than 35 kilopascals at 25% deflection,
the compressible silicone foam has a compression force deflection of less than 100 kilopascals at 50% deflection, and
the compressible silicone foam has a compression force deflection of less than 1000 kilopascals at 80% deflection;
wherein compression force deflection is determined in accordance with ASTM D1056-20.

17. An assembly for a battery comprising the compressible silicone foam of claim 16 disposed on a surface of an electrochemical cell, preferably a lithium-ion electrochemical cell.

18. A battery comprising:
the assembly for a battery of claim 17; and
a housing at least partially enclosing the assembly for a battery.

19. A method for forming a compressible silicone foam sheet, the method comprising:
casting the curable composition of claim 1 onto a first release layer;
placing a second release layer on a side of the cast curable composition opposite the first release liner to form a multilayer structure;
passing the cast curable composition on the substrate through the nip of two rotating rollers to meter the amount of curable composition; and
curing the curable composition to form the compressible silicone foam sheet.

20. A compressible silicone foam formed according to the method of claim 19.
